(19) United States
(12) Patent Application Publication
(10) Pub. No.: US 2024/0426395 A1
(43) Pub. Date: Dec. 26, 2024

(54) REMOTE EVALUATION OF HYDRAULIC VALVES

(71) Applicants: Chevron U.S.A. Inc., San Ramon, CA (US); Chevron Australia Pty Ltd, Perth (AU)

(72) Inventors: Hailing An, Houston, TX (US); Scott Eric Weatherwax, Timnath, CO (US); Miao Miao, Danville, CA (US); Minh Duc Vo, Perth (AU)

(21) Appl. No.: 18/339,163

(22) Filed: Jun. 21, 2023

(51) Int. Cl. F16K 37/00

(52) U.S. Cl. CPC F16K 37/0083

(57) ABSTRACT

A method for remotely evaluating a hydraulic valve may include obtaining multiple values associated with measurements of a parameter, where the measurements are measured by multiple sensor devices, where the sensor devices are configured to measure the parameter at multiple locations along a network of hydraulic lines that circulates a hydraulic fluid with respect to an actuator of the hydraulic valve, and where the parameter is associated with an actuator of the hydraulic valve during a subterranean field operation; executing an algorithm using the measurements to generate a result; comparing the result of the algorithm with a range of acceptable values, where the range of acceptable values is established using prior results of the algorithm; and determining that the hydraulic valve has a potential failure when the result falls outside the range of acceptable values.

### TECHNICAL FIELD

The present application is related to subsea valves and, more particularly, to remote evaluation of hydraulic valves.

### BACKGROUND

Subsea valves used in oil and gas field operations serve critical purposes during various field operations. Each valve used in a process has a signature (also called a profile) in all states (e.g., closing, opening, staying closed, staying open) of its operation. For example, each time a valve is actuated, a signature of that valve can be generated. In subsea operations, these valves are not easily accessible. Further, certain types of valves, such as hydraulic valves, do not provide much information as to their operational condition from a mere external visual inspection.

### SUMMARY

In general, in one aspect, the disclosure relates to a method for remotely evaluating a hydraulic valve. The method may include obtaining a plurality of values associated with measurements of a parameter, wherein the measurements are measured by a plurality of sensor devices, wherein the plurality of sensor devices are configured to measure the parameter at a plurality of locations along a network of hydraulic lines that circulates a hydraulic fluid with respect to an actuator of the hydraulic valve, and wherein the parameter is associated with an actuator of the hydraulic valve during a subterranean field operation. The method may also include executing an algorithm using the plurality of values to generate a result. The method may further include comparing the result of the algorithm with a range of acceptable values, where the range of acceptable values is established using prior results of the algorithm. The method may also include determining that the hydraulic valve has a potential failure when the result falls outside the range of acceptable values.

In another aspect, the disclosure relates to a system for remotely evaluating a hydraulic valve. The system may include a plurality of sensor devices that are configured to measure a parameter at a plurality of locations along a network of hydraulic lines that circulates a hydraulic fluid with respect to an actuator of the hydraulic valve, and where the parameter is associated with an actuator of the hydraulic valve during a subterranean field operation. The system may also include a controller communicably coupled to the plurality of sensor devices, where the controller may be configured to obtain a plurality of values associated with measurements of the parameter, where the measurements are measured by the plurality of sensor devices. The controller may also be configured to execute an algorithm using the plurality of values to generate a result. The controller may further be configured to compare the result of the algorithm with a range of acceptable values, where the range of acceptable values is established using prior results of the algorithm. The controller may also be configured to determine that the hydraulic valve has a potential failure when the result falls outside the range of acceptable values.

In yet another aspect, the disclosure relates to a non-transitory computer readable medium comprising computer readable program code, which when executed by a computer processor, enables the computer processor to facilitate obtaining a plurality of values associated with measurements of a parameter, where the measurements are measured by a plurality of sensor devices, where the plurality of sensor devices are configured to measure the parameter at a plurality of locations along a network of hydraulic lines that circulates a hydraulic fluid with respect to an actuator of the hydraulic valve, and where the parameter is associated with an actuator of the hydraulic valve during a subterranean field operation. The computer processor may also be enabled to facilitate executing an algorithm using the plurality of measurements to generate a result. The computer processor may further be enabled to facilitate comparing the result of the algorithm with a range of acceptable values, where the range of acceptable values is established using prior results of the algorithm. The computer processor may also be enabled to facilitate determining that the hydraulic valve has a potential failure when the result falls outside the range of acceptable values.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIG. 1 shows a diagram of a subsea field system in which example embodiments may be used.

FIGS. 2A and 2B show a block diagram of a system for remotely evaluating hydraulic subsea valves according to certain example embodiments.

FIG. 3 shows a diagram of the hydraulic subsea valve evaluation system of the system FIGS. 2A and 2B according to certain example embodiments.

FIG. 4 shows a computing device in accordance with certain example embodiments.

FIG. 5 shows a hydraulic valve system with the hydraulic valve being moved toward a fully open position according to certain example embodiments.

FIG. 6 shows the hydraulic valve system of FIG. 5 with the hydraulic valve being moved toward a fully closed position according to certain example embodiments.

FIG. 7 shows a graph illustrating evaluating hydraulic subsea valves according to certain example embodiments.

FIG. 8 shows a graph illustrating evaluating hydraulic subsea valves according to certain example embodiments.

FIGS. 9A through 9D show a graph and related equations illustrating evaluating hydraulic subsea valves according to certain example embodiments.

FIG. 10 shows a flowchart of a method for evaluating hydraulic subsea valves according to certain example embodiments.

FIGS. 11 and 12 show graphs with scatter plots of various indicators for multiple hydraulic subsea valves according to certain example embodiments.

FIGS. 13 through 16 shows graphs of performance statistics over time for hydraulic subsea valves according to certain example embodiments.

FIGS. 17 and 18 show graphs of performance signatures for a hydraulic subsea valves according to certain example embodiments.

### DETAILED DESCRIPTION OF THE INVENTION

The example embodiments discussed herein are directed to systems, apparatus, methods, and devices for remotely evaluating hydraulic valves. Example embodiments may be used with hydraulic valves that are subsea or land-based. Therefore, when the term “hydraulic subsea valve” is used herein, the associated example embodiment shown and described may equally apply to a hydraulic valve located outside of water. Similarly, when the term “hydraulic valve” is used herein, the associated example embodiment shown and described may equally apply to a hydraulic subsea valve located in a subsea environment.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

A “subterranean formation” refers to practically any volume under a surface. For example, it may be practically any volume under a terrestrial surface (e.g., a land surface), practically any volume under a seafloor, etc. Each subsurface volume of interest may have a variety of characteristics, such as petrophysical rock properties, reservoir fluid properties, reservoir conditions, hydrocarbon properties, or any combination thereof. For example, each subsurface volume of interest may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to: shale gas, shale oil, tight gas, tight oil, tight carbonate, carbonate, vuggy carbonate, unconventional (e.g., a permeability of less than 25 millidarcy (mD) such as a permeability of from 0.000001 mD to 25 mD)), diatomite, geothermal, mineral, etc. The terms “formation”, “subsurface formation”, “hydrocarbon-bearing formation”, “reservoir”, “subsurface reservoir”, “subsurface area of interest”, “subsurface region of interest”, “subsurface volume of interest”, and the like may be used synonymously. The term “subterranean formation” is not limited to any description or configuration described herein.

A “well” or a “wellbore” refers to a single hole, usually cylindrical, that is drilled into a subsurface volume of interest. A well or a wellbore may be drilled in one or more directions. For example, a well or a wellbore may include a vertical well, a horizontal well, a deviated well, and/or other type of well. A well or a wellbore may be drilled in the subterranean formation for exploration and/or recovery of resources. A plurality of wells (e.g., tens to hundreds of wells) or a plurality of wellbores are often used in a field depending on the desired outcome.

A well or a wellbore may be drilled into a subsurface volume of interest using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the subterranean formation, the hydrocarbons, and/or other factors.

A well may include a plurality of components, such as, but not limited to, a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof. In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure may be inferred to that component. Conversely, if a component in a figure is labeled but not described, the description for such component may be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of remotely evaluating hydraulic subsea valves will be described more fully hereinafter with reference to the accompanying drawings, in which example embodiments of remotely evaluating hydraulic subsea valves are shown. Remotely evaluating hydraulic subsea valves may, however, be embodied in many different forms and should not be construed as limited to the example embodiments set forth herein. Rather, these example embodiments are provided so that this disclosure will be thorough and complete, and will fully convey the scope of remotely evaluating hydraulic subsea valves to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of remotely evaluating hydraulic subsea valves. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

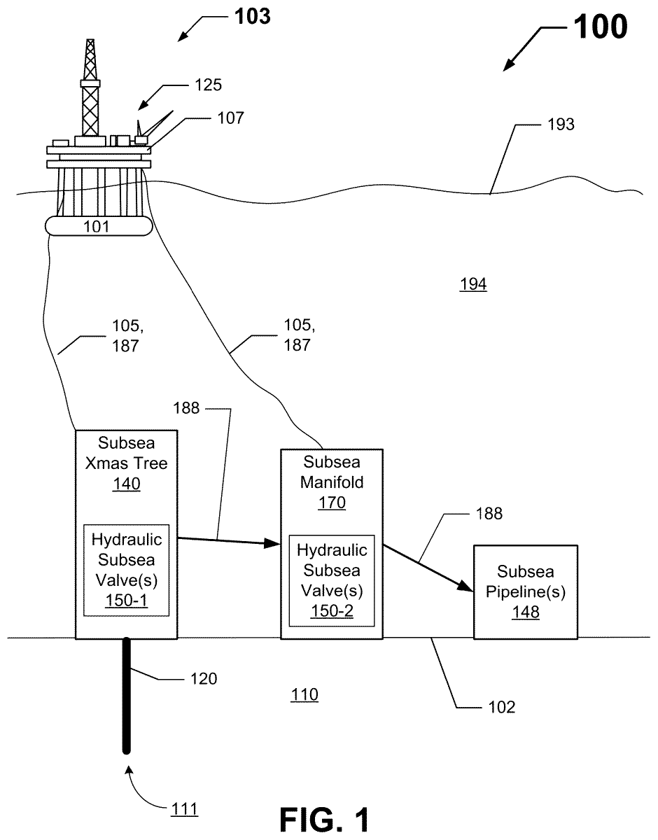

FIG. 1 shows a subsea field system 100 in which example embodiments may be used. The system 100 in this case includes a floating structure 103 in the form of a semi-submersible platform that floats in a large and deep body of water 194. Part (e.g., the topsides 107) of the floating structure 103 is above the water line 193, and at least part (e.g., part of the hull 101) of the rest of the floating structure 103 is in the water 194 below the water line 193. The floating structure 103 in this case is used for subterranean field operations (also called subsea field operations herein), in which exploration and production phases (also called stages) of the subsea field operation are executed to extract one or more subterranean resources 111 (e.g., oil, natural gas, water, hydrogen gas) from and/or inject resources (e.g., carbon monoxide, carbon dioxide, water) into the subterranean formation 110 via a wellbore 120.

In alternative embodiments, as when a subsea operation is close to land, the structure 103 may be land-based rather than floating. Further, in some cases, a field operation involves multiple wellbores 120 that originate from the same proximate location (sometimes called a pad) on the seabed 102. In such cases, the wellbores 120 are drilled and completed one at a time, which means that with all else being equal among the wellbores 120, the oldest wellbore 120 on production has a lower pressure compared to the pressure of the newest wellbore 120 on production. Also, in such cases, there may be one subsea Xmas tree 140 for each wellbore 120.

To extract a subterranean resource 111 from a wellbore 120 on production, a subsea Xmas tree 140 is disposed toward the top of the wellbore 120 at the seabed 102. The Xmas tree 140 is an assembly of valves (including one or more hydraulic subsea valves 150-1), piping (e.g., piping 188), casing spools, and fittings used to regulate the flow of the fluid (e.g., oil, natural gas, water) flowing through the piping 188. Additional piping 188 transfers the subterranean resource 111 between the subsea Xmas tree 140 and a subsea manifold 170 that is located in the water 194.

The subsea manifold 170 is an arrangement of piping (e.g., piping 188), valves (including one or more hydraulic subsea valves 150-2), and/or other components that are configured to combine, distribute, control, monitor, and/or otherwise manipulate the fluid flowing through the piping 188 from the Xmas tree 140 and/or other Xmas trees. The subsea manifold 170 may be a standalone component of the system 100. Alternatively, the subsea manifold 170 may be part of another component and/or subsystem (e.g., integrated with the Xmas tree 140). In alternative embodiments, the system 100 may include multiple subsea manifolds 170, which may be arranged in series and/or in parallel with each other.

Additional piping 188 transfers the subterranean resource 111 between the subsea manifold 170 and one or more subsea pipelines 148. There may be one or more of a number of components and/or systems (e.g., a subsea electrical pump, a subsea compressor, a subsea process cooler) positioned between a subsea Xmas tree 140 and the subsea pipelines 148 to assist in extracting the subterranean resource 111 from the wellbore 120 and/or injecting the subterranean resource 111 into the wellbore 120. There may be one or more communication links 105 and/or power transfer links 187 between one or more of the subsea components (e.g., the subsea Xmas tree 140, a subsea manifold, the subsea manifold 170, one or more of the subsea pipelines 148) and one or more components (e.g., a generator, a controller, a compressor) disposed on the topsides 107 of the floating structure 103 (or land-based structure 103, as the case may be).

The subsea Xmas tree 140 is a stack of vertical and horizontal valves, spools, pressure gauges, chokes, and/or other components installed as an assembly on a subsea wellhead. The subsea Xmas tree 140 is configured to provide a controllable interface between the wellbore 120 and production facilities (e.g., via the subsea pipeline 148). The various valves (including the one or more hydraulic subsea valves 150-1) of the subsea Xmas tree 140 may be used for such purposes as testing, servicing, regulating, and/or choking the stream of produced subterranean resources 111 coming up from the wellbore 120 and/or flowing down into the wellbore 120.

Each subsea pipeline 148 (also sometimes called a submarine pipeline 148) is a series of pipes, coupled end to end, that is laid at or near to the seabed 102. A subsea pipeline 148 moves the subterranean resource 111 from the area of the wellbore 120 to some other location, typically for a midstream process (e.g., oil refining, natural gas processing). The piping 188, also located subsea, may include multiple pipes, ducts, elbows, joints, sleeves, collars, and similar components that are coupled to each other (e.g., using coupling features such as mating threads) to establish a network for transporting the subterranean resource 111 between the subsea Xmas tree 140 and the subsea manifold 170, and also between the subsea manifold 170 and one or more of the subsea pipelines 148. While not shown in FIG. 1, in alternative embodiments of the system 100, piping 188 may run from the floating structure 103 to one or more components (e.g., the subsea manifold 170). Each component of the piping 188 may have an appropriate size (e.g., inner diameter, outer diameter) and be made of an appropriate material (e.g., steel) to safely and efficiently handle the pressure, temperature, flow rate, and other characteristics of the subterranean resource 111 at the depth in the water 194.

In this example, there is an example hydraulic subsea valve evaluation system 125 on the topsides 107 of the floating structure 103. The hydraulic subsea valve evaluation system 125 is configured to use real time data, captured over time, to determine whether a hydraulic subsea valve 150 (e.g., a hydraulic subsea valve 150-1, a hydraulic subsea valve 150-2) is failing or has failed without having to first subject the hydraulic subsea valve 150 to a visual (e.g., by a ROV) or manual inspection.

In alternative embodiments, the example hydraulic subsea valve evaluation system 125 may be located at some other location (e.g., on an adjacent floating structure, in an office building on land, in a trailer on land at a production complex). In some cases, the example hydraulic subsea valve evaluation system 125 may be distributed among multiple locations (e.g., part of the example hydraulic subsea valve evaluation system 125 is located on the topsides 107 of the floating structure 103, and another part of the topsides 107 of the floating structure 103 is located in an office building).

Each communication link 105 may include wired (e.g., Class 1 electrical cables, electrical connectors, Power Line Carrier, RS485) and/or wireless (e.g., sound or pressure waves in the water 194, Wi-Fi, Zigbee, visible light communication, cellular networking, Bluetooth, Bluetooth Low Energy (BLE), ultrawide band (UWB), WirelessHART, ISA100) technology. A communication link 105 may transmit signals (e.g., communication signals, control signals, data) from one component (e.g., a controller) of the system 100 to another (e.g., a hydraulic subsea valve 150-1 on the subsea Xmas tree 140).

Each power transfer link 187 may include one or more electrical conductors, which may be individual or part of one or more electrical cables. In some cases, as with inductive power, power may be transferred wirelessly using power transfer links 187. A power transfer link 187 may transmit power from one component (e.g., a battery, a generator) of the system 100 to another (e.g., a motor on a subsea manifold). Each power transfer link 187 may be sized (e.g., 12 gauge, 18 gauge, 4 gauge) in a manner suitable for the amount (e.g., 480V, 24V, 120V) and type (e.g., alternating current, direct current) of power transferred therethrough. In this case, the communication links 105 and the power transfer links 187 are in the form of electrical cables.

The system 100 can, in alternative embodiments, include additional and/or alternative features and/or components, depending on the objective of the field operation. For example, if the wellbore 120 is an injection well, the system 100 may include additional components that may include, but are not limited to, a pump and fluid handling system at the topsides 107, a riser, a tubing sting, and casing. In any case, the example hydraulic subsea valve evaluation system 125 may be used to monitor and evaluate, in real time, the various hydraulic subsea valves 150 in the system 100.

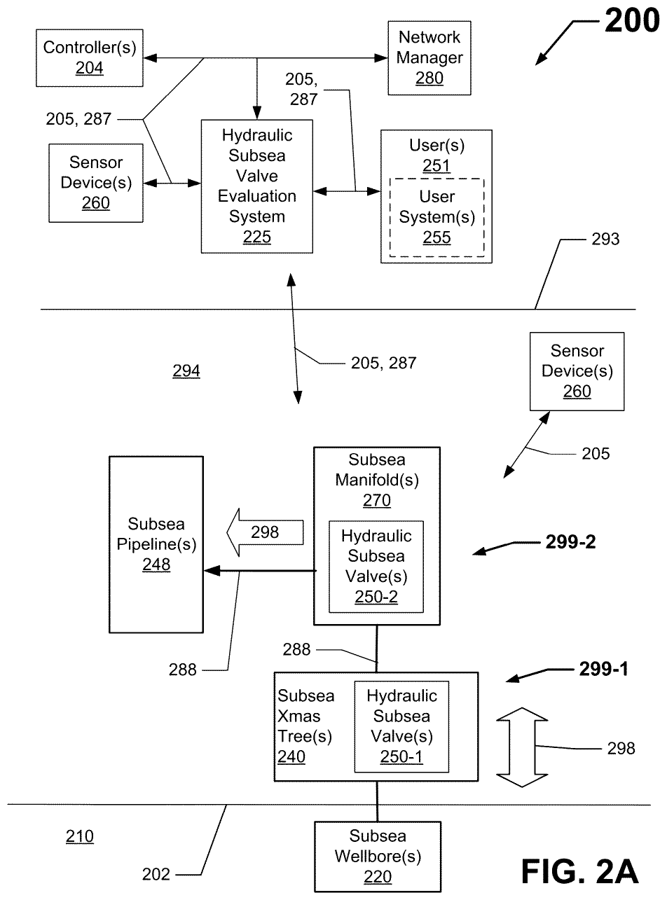

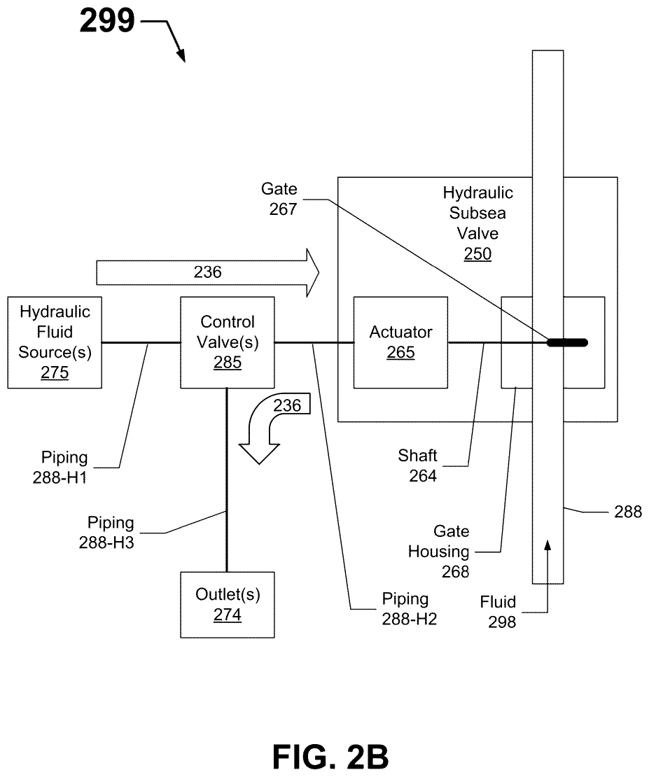

FIGS. 2A and 2B show a block diagram of a system 200 for remotely evaluating hydraulic subsea valves 250 according to certain example embodiments. Specifically, FIG. 2A shows a block diagram of the system 200, and FIG. 2B shows a block diagram of a hydraulic subsea valve system 299 of the system 200 of FIG. 2A. Referring to FIGS. 1 through 2B, the system 200 of FIGS. 2A and 2B includes one or more subsea wells 220, one or more subsea Xmas trees 240 (each including one or more hydraulic subsea valves 250-1), one or more subsea manifolds 270 (each including one or more hydraulic subsea valves 250-2), one or more subsea pipelines 248, one or more controllers 204, one or more sensor devices 260, one or more users 251 (including one or more optional user systems 255), a network manager 280, an example hydraulic subsea valve evaluation system 225, piping 288, and multiple valves (aside from the hydraulic subsea valves 250). The one or more subsea Xmas trees 240, the one or more subsea manifolds 270, the one or more subsea pipelines 248, the hydraulic subsea valve evaluation system 225, and the piping 288 may be substantially the same as the subsea Xmas tree 140, the subsea manifold 170, the one or more subsea pipelines 148, subsea valve evaluation system 125, and the piping 188 discussed above with respect to FIG. 1. Each subsea Xmas tree 240 is located at or just above the seabed 202.

The components shown in FIGS. 2A and 2B are not exhaustive, and in some embodiments, one or more of the components shown in FIGS. 2A and 2B may not be included in the example system 200. Any component of the system 200 may be discrete or combined with one or more other components of the system 200. Also, one or more components of the system 200 may have different configurations. For example, one or more sensor devices 260 may be disposed above the water line 293 rather than all being submerged in the water 294. As another example, a controller 204, rather than being a stand-alone device, may be part of one or more other components (e.g., a subsea manifold 270, the subsea valve evaluation system 225, a subsea Xmas tree 240, a hydraulic subsea valve system 299) of the system 200.

In some cases, the users 251 (including the associated user systems 255), the controllers 204, and the network manager 280 may be located on the topsides (e.g., topsides 107) of a floating structure (e.g., floating structure 103) or a land-based structure (e.g., land-based structure 103). In addition, or in the alternative, one or more users 251 (including any associated user system 255), one or more controllers 204, and/or the network manager 280 may be located elsewhere (e.g., in an office building on land, in the water 294).

A user 251 may be any person that interacts, directly or indirectly, with the example hydraulic subsea valve evaluation system 225 and/or any other component of the system 200. Examples of a user 251 may include, but are not limited to, a business owner, an engineer, a company representative, a geologist, a consultant, a contractor, and a manufacturer's representative. A user 251 may use one or more user systems 255, which may include a display (e.g., a GUI). A user system 255 of a user 251 may interact with (e.g., send data to, obtain data from) the hydraulic subsea valve evaluation system 225, a controller 204, the network manager 280, and/or any other component of the system 200 via an application interface and using the communication links 205, which are substantially the same as the communication links 105 discussed above with respect to FIG. 1. The user 251 may also interact directly with the hydraulic subsea valve evaluation system 225, a controller 204, the network manager 280, and/or any other component of the system 200 through a user interface (e.g., keyboard, mouse, touchscreen).

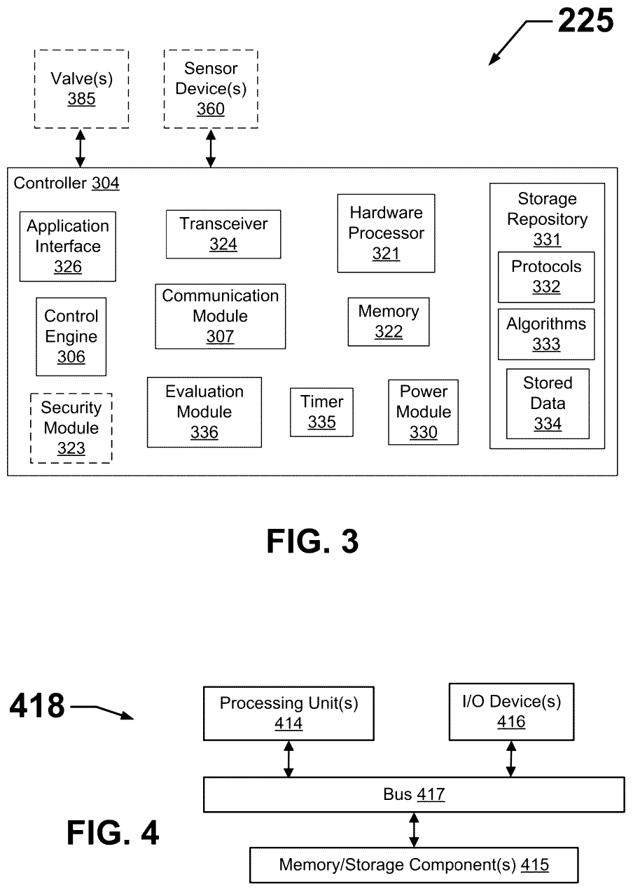

A user system 255 of a user 251 interacts with (e.g., sends data to, receives data from) the hydraulic subsea valve evaluation system 225 via an application interface (discussed below with respect to FIG. 3). Examples of a user system 255 may include, but are not limited to, a cell phone with an app, a laptop computer, a handheld device, a smart watch, a desktop computer, and an electronic tablet. In some cases, a user 251 (including an associated user system 255) may also interact directly with the network manager 280, one or more of the controllers 204, and/or one or more of the sensor devices 260 in the system 200 using one or more communication links 205.

The network manager 280 is a device or component that controls all or a portion (e.g., a communication network, a controller 204, the hydraulic subsea valve evaluation system 225) of the system 200. The network manager 280 may be substantially similar to the controller 304 of the hydraulic subsea valve evaluation system 225, discussed below. For example, the network manager 280 may include a controller that has one or more components and/or similar functionality to some or all of the controller 304. Alternatively, the network manager 280 may include one or more of a number of features in addition to, or altered from, the features of the controller 304. As described herein, control and/or communication with the network manager 280 may include communicating with one or more other components of the same system 200 or another system. In such a case, the network manager 280 may facilitate such control and/or communication. The network manager 280 may be called by other names, including but not limited to a master controller, a network controller, and an enterprise manager. The network manager 280 may be considered a type of computer device, as discussed below with respect to FIG. 4.

As discussed below with respect to FIG. 3, the hydraulic subsea valve evaluation system 225 may include multiple components. For example, in certain example embodiments, the hydraulic subsea valve evaluation system 225 may include a controller, one or more valves, one or more sensor devices, and/or other equipment that may be used, for example, to remotely evaluate one or more hydraulic subsea valves 250. The hydraulic subsea valve evaluation system 225 in this example is directly communicably coupled to the one or more controllers 204, the one or more users 251 (including associated user systems 255), the network manager 280, and one or more components (e.g., part of a subsea Xmas tree 240, part of a subsea manifold 270) in the water 294.

As mentioned above, the system 200 may include one or more controllers 204. Each controller 204 may be communicably coupled to the hydraulic subsea valve evaluation system 225. A controller 204 may also be communicably coupled to one or more other components of the system 200, including but not limited to the network manager 280, a user 251 (including an associated user system 255), a sensor device 260, a subsea Xmas tree 240 (or portions thereof), and a subsea manifold 270 (or portions thereof). A controller 204 performs a number of functions that include obtaining and sending data, evaluating data, following protocols, running algorithms, and sending commands. A controller 204 may include one or more of a number of components.

A controller 204 of FIG. 2A may include one or more of the components of the controller 304 (discussed below with respect to FIG. 3) of the combustion control system 225 and/or perform one or more of the functions of the controller 304 of the hydraulic subsea valve evaluation system 225. For example, components of a controller 304 may include, but are not limited to, a control engine, a communication module, a timer, a counter, a power module, a storage repository, a hardware processor, memory, a transceiver, an application interface, and a security module.

When there are multiple controllers 204 (e.g., one controller 204 for a subsea Xmas tree 240, another controller 204 for a subsea manifold 270, yet another controller 204 for a system on the topsides 107), each controller 204 may operate independently of each other. Alternatively, one or more of the controllers 204 may work cooperatively with each other. As yet another alternative, one of the controllers 204 may control some or all of one or more other controllers 204 in the system 200. As still another alternative, each controller 204 may be in communication with and controlled by the controller 304 of the hydraulic subsea valve evaluation system 225. Each controller 204 may be considered a type of computer device, as discussed below with respect to FIG. 4.

Each sensor device 260 includes one or more sensors that measure one or more parameters (e.g., pressure, flow rate, temperature, humidity, fluid content, voltage, current, presence of an object or component, chemical elements in a fluid). Examples of a sensor of a sensor device 260 may include, but are not limited to, a temperature sensor, a flow sensor, a pressure sensor, a proximity sensor, a gas spectrometer, a voltmeter, an ammeter, a permeability meter, a porosimeter, and a camera. A sensor device 260 may be integrated with or measure a parameter associated with one or more components of the system 200. For example, a sensor device 260 may be configured to measure a parameter (e.g., flow rate, pressure, temperature) of a subterranean resource (e.g., subterranean resource 111) received by a Xmas tree 240 and flowing through the piping 288. In some cases, a parameter may be associated with an actuator (discussed below) of the hydraulic subsea valve 250 during a subterranean field operation.

In some cases, a number of sensor devices 260, each measuring a different parameter, may be used in combination to determine and confirm whether a controller 204 should take a particular action (e.g., operate a valve, operate or adjust the operation of a pump, send a notification). When a sensor device 260 includes its own controller (e.g., a controller 204), or portions thereof, then the sensor device 260 may be considered a type of computer device, as discussed below with respect to FIG. 4.

The system 200 includes multiple hydraulic subsea valve systems 299 (e.g., hydraulic subsea valve system 299-1, hydraulic subsea valve system 299-2). Each hydraulic subsea valve system 299 is configured to control the flow of a fluid 298 through a section of the piping 288. In this example, the fluid 298 is a subterranean resource (e.g., subterranean resource 111) that flows out of one or more of the wellbores 220 through the piping 288. In alternative embodiments, the fluid 298 may be something else (e.g., water, a carbon-based gas) that flows through the piping 288 into one or more of the wellbores 220.

Each hydraulic subsea valve system 299 may include multiple components. When the system 200 includes multiple hydraulic subsea valve systems 299, as in this case, one hydraulic subsea valve system 299 may be configured the same as, or differently than, one or more of the other hydraulic subsea valve systems 299 in the system 200. For example, as detailed in FIG. 2B, a hydraulic subsea valve system 299 may include one or more hydraulic fluid sources 275, piping 288-H (also sometimes called a network of hydraulic lines 288-H herein), one or more control valves 285, one or more outlets 274, and one or more hydraulic subsea valves 250.

The hydraulic fluid source 275 is configured to originate and deliver hydraulic fluid 236 to the actuator 265 of one or more of the hydraulic subsea valves 250. Each hydraulic fluid source 275 may be located, in whole or in part, in the water 294. Alternatively, a hydraulic fluid source 275 may be located entirely above the water line 293 (e.g., on the topsides 107 of a floating structure 103). A hydraulic fluid source 275 may include one or more of a number of various pieces of equipment. Such equipment may include, but are not limited to, a pump, a motor, a compressor, a tank, a reservoir, a gear, an adjustable speed drive, a housing, piping (e.g., piping 288), a sensor device (e.g., sensor device 260), and a controller (e.g., controller 204). A hydraulic fluid source 275 may supply hydraulic fluid 236 to a single hydraulic subsea valve 250 or multiple hydraulic subsea valves 250 (e.g., simultaneously, individually).

The hydraulic fluid 236 is a medium by which energy is transferred within an actuator 265 of a hydraulic subsea valve 250. The hydraulic fluid 236 may be in liquid form and/or gaseous form. The hydraulic fluid 236 may be or include water, a natural oil, a synthetic compound, an alloy, and/or some other chemical compound. In certain example embodiments, the hydraulic fluid 236 is environmentally safe. For example, the hydraulic fluid 236 may be discharged into the water 294 in compliance with applicable regulatory standards, law, and/or regulations.

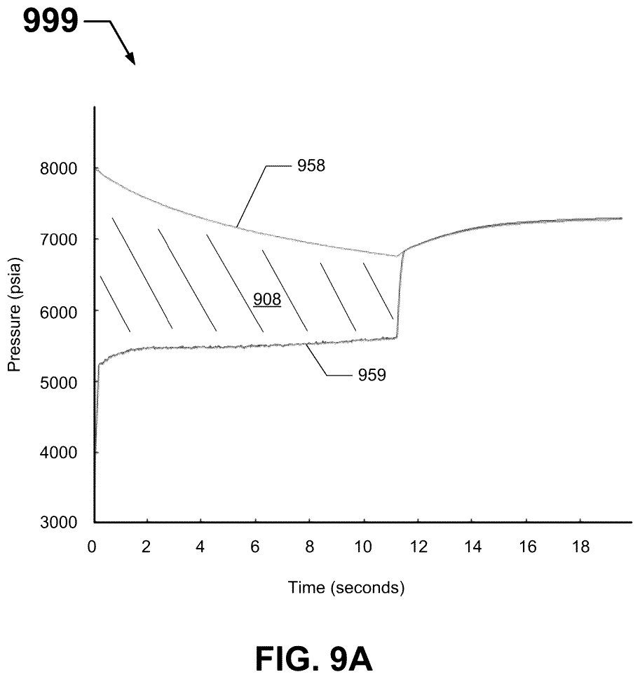

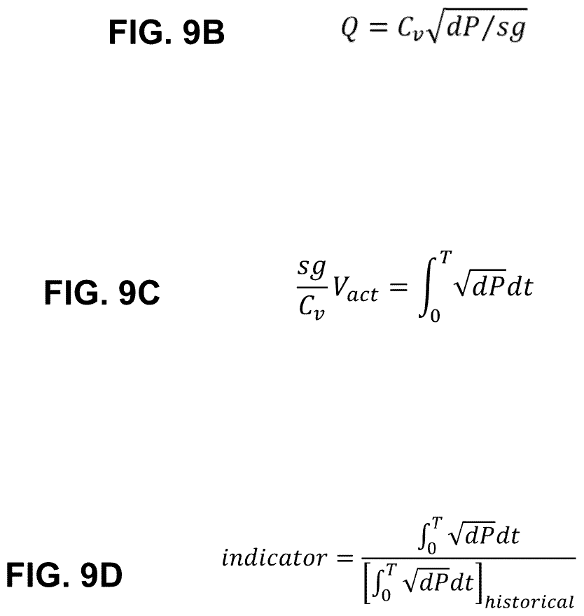

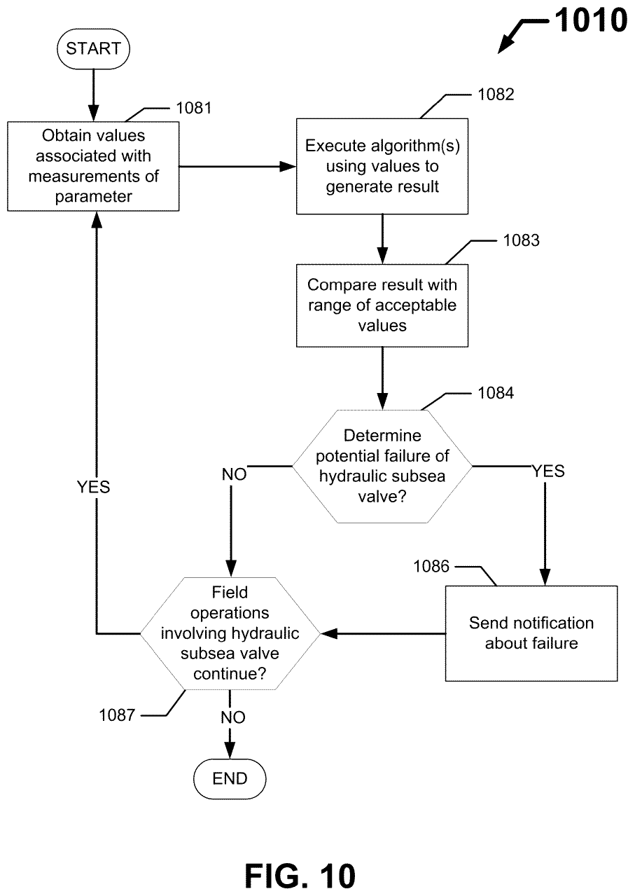

The one or more control valves 285 of the hydraulic subsea valve system 299 are configured to regulate the flow of the hydraulic fluid 236 through the piping 288-H between the hydraulic subsea valve 250, the hydraulic fluid source 275, and the outlet 274. In this case, piping 288-H1 (also called a main line in the network of hydraulic lines 588-H) is located between the hydraulic fluid sources 275 and the control valves 285. Piping 288-H2 (also called an input line in the network of hydraulic lines 588-H) is located between the control valves 285 and the hydraulic subsea valve 250. Piping 288-H3 (also called a discharge line in the network of hydraulic lines 588-H) is located between the control valves 285 and the outlets 274. The piping 288-H may be substantially the same as the piping 188 discussed above. In certain example embodiments, as shown below with respect to FIGS. 9 and 10, each hydraulic subsea valve system 299 may include one or more sensor devices (e.g., sensor device 260, sensor device 360).

Each control valve 285 of a hydraulic subsea valve system 299 may allow the hydraulic fluid 236 to flow in either direction (e.g., toward the actuator of a hydraulic subsea valve 250, away from the actuator of a hydraulic subsea valve 250) therethrough. A control valve 285 may have one or more of any of a number of configurations, including but not limited to a guillotine valve, a ball valve, a gate valve, a butterfly valve, a pinch valve, a needle valve, a plug valve, a diaphragm valve, and a globe valve. One control valve 285 of a hydraulic subsea valve system 299 may be configured the same as or differently compared to a control valve 285 of another hydraulic subsea valve system 299 in the system 200. A control valve 285 may be controlled manually by a user 251 (including an associated user system 255), automatically by a controller 204, and/or in any other suitable manner. In certain example embodiments, a control valve 285 of a hydraulic subsea valve system 299 is not hydraulically actuated.

An outlet 274 of the hydraulic subsea valve system 299 is configured to receive and/or provide a channel to discharge hydraulic fluid 236 to exit the hydraulic subsea valve system 299. An outlet 274 may include one or more components that include, but are not limited to, a tank, a vessel, an open-end of the piping 288-H3, some other component, or any combination thereof. In certain example embodiments, the outlet 274 is an open distal end of the piping 288-H3 that allows hydraulic fluid 236 to be discharged into the water 294. The outlet 274 is configured to allow hydraulic fluid 236 that is forced out of the actuator 265 (e.g., when the gate 267 of the hydraulic subsea valve 250 moves from a fully open position toward a fully closed position) to flow thereinto and/or therethrough.

A hydraulic subsea valve 250 may also include multiple components. In this case, as shown in FIG. 2B, the hydraulic subsea valve 250 includes an actuator 265, a shaft 264, and a gate 267 movably positioned within a gate housing 268. The actuator 265 of the hydraulic subsea valve 250 is configured to change the position of the gate 267 within the gate housing 268. The actuator 265 is connected to the gate 267 through the shaft 264. The actuator 265 may have any of a number of configurations using any of a number of components (e.g., a resilient device, a piston, a piston housing, a shaft). Regardless of the configuration of the actuator 265, the actuator operates based on the flow of hydraulic fluid 236 under pressure. In other words, when the hydraulic fluid 236 flows into the actuator 265 under a pressure sufficient to exceed a threshold value, the actuator 265 operates, which in turn changes the state (e.g., from fully open to fully closed, from fully closed to fully open) of the gate 267 with respect to the gate housing 268, which in turn affects a change in the flow of the fluid 298 through the piping 288.

When the actuator 265 operates based on the sudden flow of the pressurized hydraulic fluid (or sudden lack thereof), the shaft 264 moves radially inward or outward, depending on the configuration of the actuator 265. Specifically, the proximal end of the shaft 264 is coupled to the actuator 265, and the distal end of the shaft 264 is coupled to the gate 267. The shaft 264 may be rigid or substantially rigid so that movement of the actuator 265 translates into a substantially equal movement of the shaft 264.

The gate housing 268 of the hydraulic subsea valve 250 encompasses a portion of the piping 288 through which the fluid 298 flowing to or from the wellbore 220 flows. The gate housing 268 may be configured to form a seal with the outer perimeter of the piping 288 above and below the gate 267 to prevent any of the fluid 298 from leaking. In some cases, the gate housing 268 serves as a joint between two adjacent pipes in the piping 288. The gate housing 268 may also have an opening for the shaft 264 to be disposed and move therein. The gate housing 268 may be configured to form a seal with the shaft 264. In such a case, the friction on the shaft 264 that results from the seal may be known to calibrate how the pressure of the hydraulic fluid 236 in the actuator 265 translates to the force required to move the shaft 264. The gate housing 268 may form a cavity in which the gate 267 is located. The cavity of the gate housing 268 may be sufficiently configured to allow the gate 267 to move within the cavity through the full range of motion of the gate 267.

The gate 267 of the hydraulic subsea valve 250 is configured to block some, all, or none of the piping 288, depending on the position of the gate 267 as driven by the actuator 265 and translated through the shaft 264. The gate 267 may be of any shape and/or size sufficient to perform its purpose of fully or partially blocking the piping 288. The gate 267 may have a default position that coincides with the default position of the actuator 265. For example, when the actuator 265 is in its default position (e.g., has no hydraulic fluid 236 flowing therein, has hydraulic fluid 236 flowing therein but at an insufficient pressure), the gate 267 may be in a default position (e.g., fully open, fully closed) relative to the piping 288. When the gate 267 is not in its default position, the gate 267 may have any position relative to the piping 288 within a range of positions that is bounded by the opposite state (e.g., fully closed, fully open) of the default position.

When a fluid 298 (e.g., water, a carbon-based gas) is injected into a wellbore 220, the fluid 298 may flow optionally through the subsea manifold 270 through piping 288 to the subsea Xmas tree 240 and down the wellbore into the subterranean formation 210. When a fluid (e.g., a subterranean resource 111) is extracted from a wellbore 220, the fluid flows through the subsea Xmas tree 240, through piping 288 to a subsea manifold 270, and through additional piping 288 to one or more of the subsea pipelines 248. In either case, the fluid 298 flows through the subsea Xmas tree 240 and the subsea manifolds 270 when the hydraulic subsea valves 250 are in an open position (e.g., the fully open position).

Communication between the network manager 280, the users 251 (including any associated user systems 255), the controllers 204, the subsea Xmas trees 240, the subsea manifold 270, the sensor devices 260, the subsea pipelines 248, the hydraulic subsea valve evaluation system 225, and any other components of the system 200 may be facilitated using the communication links 205, which are substantially the same as the communication links 105 discussed above with respect to FIG. 1. Similarly, the transfer of power between any two components (e.g., a hydraulic subsea valve 250-2 (or portion thereof, such as a hydraulic fluid source 275) of a subsea manifold 270 and the hydraulic subsea valve evaluation system 225, a hydraulic subsea valve 250-1 of a subsea Xmas tree 240 and the hydraulic subsea valve evaluation system 225) may be facilitated using power transfer links 287, which are substantially the same as the power transfer links 187 discussed above with respect to FIG. 1.

FIG. 3 shows a diagram of the hydraulic subsea valve evaluation system 225 of the system 200 of FIGS. 2A and 2B according to certain example embodiments. The hydraulic subsea valve evaluation system 225 of FIG. 3 includes a controller 304, one or more optional sensor devices 360, and one or more optional valves 385. In some cases, the hydraulic subsea valve evaluation system 225 may include one or more other components (e.g., a reporting module) that are not shown in FIG. 3. The optional sensor devices 360 and valves 385 of the hydraulic subsea valve evaluation system 225 may be substantially the same as the sensor devices 260 and valves 285, respectively, of the system 200 discussed above.

The components shown in FIG. 3 are not exhaustive, and in some embodiments, one or more of the components shown in FIG. 3 may not be included in the example hydraulic subsea valve evaluation system 225. Any component of the hydraulic subsea valve evaluation system 225 may be discrete or combined with one or more other components of the hydraulic subsea valve evaluation system 225. Also, one or more components of the hydraulic subsea valve evaluation system 225 may have different configurations. For example, one or more sensor devices 360 may be disposed within or disposed on other components (e.g., piping 288, a hydraulic subsea valve 250). As another example, the controller 304, rather than being a stand-alone device, may be part of one or more other components of the hydraulic subsea valve evaluation system 225 or the system 200. For instance, the hydraulic subsea valve evaluation system 225 may be part of the network manager 280.

Referring to FIGS. 1 through 3, the hydraulic subsea valve evaluation system 225 is configured to monitor and evaluate the performance of the hydraulic subsea valves 250. In some cases, the hydraulic subsea valve evaluation system 255 may also be configured to control one or more hydraulic fluid sources 275 and/or one or more control valves 285 of a hydraulic subsea valve 250 based on the evaluation of the hydraulic subsea valve 250. In some cases, the hydraulic subsea valve evaluation system 255 may further be configured to report (e.g., to a user 251 (including an associated user system 255), to the network manager 280) the results of an evaluation of one or more hydraulic subsea valves 250.

The controller 304 of the hydraulic subsea valve evaluation system 225 may include one or more of a number of components. For example, in this case, the controller 304 may include a control engine 306, an evaluation module 336, a communication module 307, a timer 335, a power module 330, a storage repository 331, a hardware processor 321, a memory 322, a transceiver 324, an application interface 326, and, optionally, a security module 323. The various components of the controller 304 may be centrally located. In addition, or in the alternative, some of the components of the controller 304 may be located remotely from (e.g., in the cloud, at an office building) one or more of the other components of the controller 304.

The storage repository 331 may be a persistent storage device (or set of devices) that stores software and data used to assist the controller 304 in communicating with one or more other components of a system, such as the users 251 (including associated user systems 255), the network manager 280, the sensor devices 260, the sensor devices 360, and any other component of the system 200 of FIG. 2 above. In one or more example embodiments, the storage repository 331 stores one or more protocols 332, one or more algorithms 333, and stored data 334.

The protocols 332 of the storage repository 331 may be any procedures (e.g., a series of method steps) and/or other similar operational processes that the control engine 306 of the controller 304 follows based on certain conditions at a point in time. The protocols 332 may include any of a number of communication protocols that are used to send and/or obtain data between the controller 304 and other components of a system (e.g., the system 200). Such protocols 332 used for communication may be a time-synchronized protocol. Examples of such time-synchronized protocols may include, but are not limited to, a highway addressable remote transducer (HART) protocol, a wirelessHART protocol, and an International Society of Automation (ISA) 100 protocol. In this way, one or more of the protocols 332 may provide a layer of security to the data transferred within a system (e.g., system 200). Other protocols 332 used for communication may be associated with the use of Wi-Fi, Zigbee, visible light communication (VLC), cellular networking, BLE, UWB, and Bluetooth.

The algorithms 333 may be or include any formulas, mathematical models, forecasts, simulations, and/or other similar tools that a component (e.g., the control engine 306, the evaluation module 336) of the controller 304 uses to reach a computational conclusion. For example, one or more algorithms 333 may be used, in conjunction with one or more protocols 332, to assist the controller 304 to obtain values associated with measurements of a parameter at one or more locations along a network of hydraulic lines (e.g., piping 288-H) that circulates a hydraulic fluid 236 with respect to an actuator 265 of a hydraulic subsea valve 250. As another example, one or more algorithms 333 may be used, in conjunction with one or more protocols 332, to assist the controller 304 to use the values associated with the measurements to generate a result (e.g., a numeric value, a range of probabilities).

As yet another example, one or more algorithms 333 may be used, in conjunction with one or more protocols 332, to assist the controller 304 to compare the result of an algorithm 333 with a range of acceptable values (e.g., stored data 334), where the range of acceptable values is established using prior results (e.g., stored data 334) of the algorithm 333. As still another example, one or more algorithms 333 may be used, in conjunction with one or more protocols 332, to assist the controller 304 to determine that a hydraulic subsea valve 250 has a potential failure when the result of an algorithm 333 falls outside the range of acceptable values. As yet another example, one or more algorithms 333 may be used, in conjunction with one or more protocols 332, to assist the controller 304 to make specific recommendations as to what portions of a hydraulic subsea valve 250 needs maintenance and/or repair.

Stored data 334 may be any data associated with the various equipment (e.g., a subsea Xmas tree 240, a subsea manifold 270), including associated components, of the system 200, the various fluids (e.g., a hydraulic fluid 236, a fluid 298 flowing through the piping 288) flowing in the system 200, the example the hydraulic subsea valve evaluation system 225, the user systems 255, the network manager 280, the sensor devices (e.g., sensor devices 260, sensor devices 360), measurements made by the sensor devices (e.g., sensor devices 260, sensor devices 360), threshold values, ranges of acceptable values, tables, results of previously run or calculated algorithms 333, updates to protocols 332 and/or algorithms 333, user preferences, and/or any other suitable data. Such data may be any type of data, including but not limited to historical data, present data, and future data (e.g., forecasts). The stored data 334 may be associated with some measurement of time derived, for example, from the timer 335.

Examples of a storage repository 331 may include, but are not limited to, a database (or a number of databases), a file system, cloud-based storage, a hard drive, flash memory, some other form of solid-state data storage, or any suitable combination thereof. The storage repository 331 may be located on multiple physical machines, each storing all or a portion of the protocols 332, the algorithms 333, and/or the stored data 334 according to some example embodiments. Each storage unit or device may be physically located in the same or in a different geographic location.

The storage repository 331 may be operatively connected to the control engine 306. In one or more example embodiments, the control engine 306 includes functionality to communicate with the users 251 (including associated user systems 255), the sensor devices 260, the sensor devices 360, the network manager 280, and any other components in the system 200. More specifically, the control engine 306 sends information to and/or obtains information from the storage repository 331 in order to communicate with the users 251 (including associated user systems 255), the sensor devices 260, the sensor devices 360, the network manager 280, and any other components of the system 200. As discussed below, the storage repository 331 may also be operatively connected to the communication module 307 in certain example embodiments.

In certain example embodiments, the control engine 306 of the controller 304 controls the operation of one or more components (e.g., the communication module 307, the timer 335, the transceiver 324) of the controller 304. For example, the control engine 306 may activate the communication module 307 when the communication module 307 is in “sleep” mode and when the communication module 307 is needed to send data obtained from another component (e.g., a sensor device 360, a controller 204) in the system 200. In addition, the control engine 306 of the controller 304 may control the operation of one or more other components (e.g., a sensor device 360, a controller 204), or portions thereof, of the system 200.

The control engine 306 of the controller 304 may communicate with one or more other components of the system 200. For example, the control engine 306 may use one or more protocols 332 to facilitate communication with the sensor devices 360 to obtain data (e.g., measurements of various parameters, such as temperature, pressure, proximity, and flow rate), whether in real time or on a periodic basis and/or to instruct a sensor device 360 to take a measurement. The control engine 306 may use measurements (including the associated values) of parameters taken by sensor devices 360 to perform one or more steps in remotely evaluating a hydraulic subsea valve 250 using one or more protocols 332 and/or one or more algorithms 333. For instance, the control engine 306 may use one or more algorithms 333 and/or protocols 332 to obtain values associated with measurements of a parameter at one or more locations along a network of hydraulic lines (e.g., piping 288-H) that circulates a hydraulic fluid 236 with respect to an actuator 265 of a hydraulic subsea valve 250.

As still another example, the control engine 306 may use one or more algorithms 333 and/or protocols 332 to use the values associated with the measurements to generate a result (e.g., a numeric value, a range of probabilities). As yet another example, the control engine 306 may use one or more algorithms 333 and/or protocols 332 to compare the result of an algorithm 333 with a range of acceptable values (e.g., stored data 334), where the range of acceptable values is established using prior results (e.g., stored data 334) of the algorithm 333. As still another example, the control engine 5306 may use one or more algorithms 333 and/or protocols 332 to determine that a hydraulic subsea valve 250 has a potential failure when the result of an algorithm 333 falls outside the range of acceptable values. As yet another example, the control engine 306 may use one or more algorithms 333 and/or protocols 332 to make specific recommendations as to what portions of a hydraulic subsea valve 250 needs maintenance and/or repair.

The control engine 306 may generate and process data associated with control, communication, and/or other signals sent to and obtained from the users 251 (including associated user systems 255), the sensor devices 260, the sensor devices 360, the network manager 280, and any other components of the system 200. In certain embodiments, the control engine 306 of the controller 304 may communicate with one or more components of a system external to the system 200. For example, the control engine 306 may interact with an inventory management system by ordering replacements for components or pieces of equipment (e.g., a sensor device 360, a control valve 285, a motor, a pump of a hydraulic fluid source 275) within the system 200 that has failed or is failing. As another example, the control engine 306 may interact with a contractor or workforce scheduling system by arranging for the labor needed to replace a component or piece of equipment in the system 200. In this way and in other ways, the controller 304 is capable of performing a number of functions beyond what could reasonably be considered a routine task.

In certain example embodiments, the control engine 306 may include an interface that enables the control engine 306 to communicate with the sensor devices 260, the sensor devices 360, the user systems 255, the network manager 280, and any other components of the system 200. For example, if a user system 255 operates under IEC Standard 62386, then the user system 255 may have a serial communication interface that will transfer data to the controller 304. Such an interface may operate in conjunction with, or independently of, the protocols 332 used to communicate between the controller 304 and the users 251 (including corresponding user systems 255), the sensor devices 260, the sensor devices 360, the network manager 280, and any other components of the system 200.

The control engine 306 (or other components of the controller 304) may also include one or more hardware components and/or software elements to perform its functions. Such components may include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The evaluation module 336 of the controller 304 of the hydraulic subsea valve evaluation system 225 may be configured to evaluate values associated with measurements of one or more sensor devices 260 and/or one or more sensor devices 360. The evaluation module 336 may use values associated with measurements of one or more parameters made by one or more sensor devices (e.g., sensor devices 260, sensor devices 360) to evaluate a hydraulic subsea valve 250. Examples of such parameters may include, but are not limited to, flow rates, pressures, composition of a fluid (e.g., a hydraulic fluid 236), proximity, and temperatures. The evaluation module 336 may additionally or alternatively determine whether a hydraulic subsea valve 250 (or portion thereof) is failing or has failed. The evaluation module 336 may use one or more protocols 332 and/or one or more algorithms 333 to perform any of its evaluations.

The communication module 307 of the controller 304 determines and implements the communication protocol (e.g., from the protocols 332 of the storage repository 331) that is used when the control engine 306 communicates with (e.g., sends signals to, obtains signals from) the user systems 255, the sensor devices 260, the sensor devices 360, the network manager 280, and any other components of the system 200. In some cases, the communication module 307 accesses the stored data 334 to determine which communication protocol is used to communicate with another component of the system 200. In addition, the communication module 307 may identify and/or interpret the communication protocol of a communication obtained by the controller 304 so that the control engine 306 may interpret the communication. The communication module 307 may also provide one or more of a number of other services with respect to data sent from and obtained by the controller 304. Such services may include, but are not limited to, data packet routing information and procedures to follow in the event of data interruption.

The timer 335 of the controller 304 may track clock time, intervals of time, an amount of time, and/or any other measure of time. The timer 335 may also count the number of occurrences of an event, whether with or without respect to time. Alternatively, the control engine 306 may perform a counting function. The timer 335 is able to track multiple time measurements and/or count multiple occurrences concurrently. The timer 335 may track time periods based on an instruction obtained from the control engine 306, based on an instruction obtained from a user 251, based on an instruction programmed in the software for the controller 304, based on some other condition (e.g., the occurrence of an event) or from some other component, or from any combination thereof. In certain example embodiments, the timer 335 may provide a time stamp for each packet of data obtained from another component (e.g., a sensor device 360) of the hydraulic subsea valve evaluation system 225.

The power module 330 of the controller 304 obtains power from a power supply (e.g., AC mains, a battery) and manipulates (e.g., transforms, rectifies, inverts) that power to provide the manipulated power to one or more other components (e.g., the timer 335, the control engine 306) of the controller 304, where the manipulated power is of a type (e.g., alternating current, direct current) and level (e.g., 12V, 24V, 120V) that may be used by the other components of the controller 304. In some cases, the power module 330 may also provide power to one or more of the sensor devices 360.

The power module 330 may include one or more of a number of single or multiple discrete components (e.g., transistor, diode, resistor, transformer) and/or a microprocessor. The power module 330 may include a printed circuit board, upon which the microprocessor and/or one or more discrete components are positioned. In addition, or in the alternative, the power module 330 may be a source of power in itself to provide signals to the other components of the controller 304. For example, the power module 330 may be or include an energy storage device (e.g., a battery). As another example, the power module 330 may be or include a localized photovoltaic power system.

The hardware processor 321 of the controller 304 executes software, algorithms (e.g., algorithms 333), and firmware in accordance with one or more example embodiments. Specifically, the hardware processor 321 may execute software on the control engine 306 or any other portion of the controller 304, as well as software used by the users 251 (including associated user systems 255), the network manager 280, and/or other components of the system 200. The hardware processor 321 may be an integrated circuit, a central processing unit, a multi-core processing chip, SoC, a multi-chip module including multiple multi-core processing chips, or other hardware processor in one or more example embodiments. The hardware processor 321 may be known by other names, including but not limited to a computer processor, a microprocessor, and a multi-core processor.

In one or more example embodiments, the hardware processor 321 executes software instructions stored in memory 322. The memory 322 includes one or more cache memories, main memory, and/or any other suitable type of memory. The memory 322 may include volatile and/or non-volatile memory. The memory 322 may be discretely located within the controller 304 relative to the hardware processor 321. In certain configurations, the memory 322 may be integrated with the hardware processor 321.

In certain example embodiments, the controller 304 does not include a hardware processor 321. In such a case, the controller 304 may include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively, FPGAs, IGBTs, ICs, and/or similar devices may be used in conjunction with one or more hardware processors 321.

The transceiver 324 of the controller 304 may send and/or obtain control and/or communication signals. Specifically, the transceiver 324 may be used to transfer data between the controller 304 and the users 251 (including associated user systems 255), the sensor devices 260, the sensor devices 360, the network manager 280, and any other components of the system 200. The transceiver 324 may use wired and/or wireless technology. The transceiver 324 may be configured in such a way that the control and/or communication signals sent and/or obtained by the transceiver 324 may be obtained and/or sent by another transceiver that is part of a user system 255, a sensor device 260, a sensor device 360, the network manager 280, and/or another component of the system 200. The transceiver 324 may send and/or obtain any of a number of signal types, including but not limited to radio frequency signals.

When the transceiver 324 uses wireless technology, any type of wireless technology may be used by the transceiver 324 in sending and obtaining signals. Such wireless technology may include, but is not limited to, Wi-Fi, Zigbee, VLC, cellular networking, BLE, UWB, and Bluetooth. The transceiver 324 may use one or more of any number of suitable communication protocols (e.g., ISA100, HART) when sending and/or obtaining signals.

Optionally, in one or more example embodiments, the security module 323 secures interactions between the controller 304, the users 251 (including associated user systems 255), the sensor devices 260, the sensor devices 360, the network manager 280, and any other components of the system 200. More specifically, the security module 323 authenticates communication from software based on security keys verifying the identity of the source of the communication. For example, user software may be associated with a security key enabling the software of a user system 255 to interact with the controller 304. Further, the security module 323 may restrict receipt of information, requests for information, and/or access to information.

A user 251 (including an associated user system 255), the sensor devices 260, the sensor devices 360, the network manager 280, and the other components of the system 200 may interact with the controller 304 using the application interface 326. Specifically, the application interface 326 of the controller 304 obtains data (e.g., information, communications, instructions, updates to firmware) from and sends data (e.g., information, communications, instructions) to the user systems 255 of the users 251, the sensor devices 260, the sensor devices 360, the network manager 280, and/or the other components of the system 200. Examples of an application interface 326 may be or include, but are not limited to, an application programming interface, a web service, a data protocol adapter, some other hardware and/or software, or any suitable combination thereof. Similarly, the user systems 255 of the users 251, the sensor devices 260, the sensor devices 360, the network manager 280, and/or the other components of the system 200 may include an interface (similar to the application interface 326 of the controller 304) to obtain data from and send data to the controller 304 in certain example embodiments.

In addition, as discussed above with respect to a user system 255 of a user 251, one or more of the sensor devices 260, one or more of the sensor devices 360, the network manager 280, and/or one or more of the other components of the system 200 may include a user interface. Examples of such a user interface may include, but are not limited to, a graphical user interface, a touchscreen, a keyboard, a monitor, a mouse, some other hardware, or any suitable combination thereof.

The controller 304, the users 251 (including associated user systems 255), the sensor devices 260, the sensor devices 360, the network manager 280, and the other components of the system 200 may use their own system or share a system in certain example embodiments. Such a system may be, or contain a form of, an Internet-based or an intranet-based computer system that is capable of communicating with various software. A computer system includes any type of computing device and/or communication device, including but not limited to the controller 304. Examples of such a system may include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system may correspond to a computer system as described below with regard to FIG. 4.

Further, as discussed above, such a system may have corresponding software (e.g., user system software, sensor device software, controller software). The software may execute on the same or a separate device (e.g., a server, mainframe, desktop personal computer (PC), laptop, PDA, television, cable box, satellite box, kiosk, telephone, mobile phone, or other computing devices) and may be coupled by the communication network (e.g., Internet, Intranet, Extranet, LAN, WAN, or other network communication methods) and/or communication channels, with wire and/or wireless segments according to some example embodiments. The software of one system may be a part of, or operate separately but in conjunction with, the software of another system within and/or outside of the system 200.

FIG. 4 illustrates one embodiment of a computing device 418 that implements one or more of the various techniques described herein, and which is representative, in whole or in part, of the elements described herein pursuant to certain example embodiments. For example, a controller 304 (including components thereof, such as a control engine 306, a hardware processor 321, a storage repository 331, a power module 330, and a transceiver 324) may be considered a computing device 418. Computing device 418 is one example of a computing device and is not intended to suggest any limitation as to scope of use or functionality of the computing device and/or its possible architectures. Neither should the computing device 418 be interpreted as having any dependency or requirement relating to any one or combination of components illustrated in the example computing device 418.

The computing device 418 includes one or more processors or processing units 414, one or more memory/storage components 415, one or more input/output (I/O) devices 416, and a bus 417 that allows the various components and devices to communicate with one another. The bus 417 represents one or more of any of several types of bus structures, including a memory bus or memory controller, a peripheral bus, an accelerated graphics port, and a processor or local bus using any of a variety of bus architectures. The bus 417 includes wired and/or wireless buses.

The memory/storage component 415 represents one or more computer storage media. The memory/storage component 415 includes volatile media (such as random access memory (RAM)) and/or nonvolatile media (such as read only memory (ROM), flash memory, optical disks, magnetic disks, and so forth). The memory/storage component 415 includes fixed media (e.g., RAM, ROM, a fixed hard drive, etc.) as well as removable media (e.g., a Flash memory drive, a removable hard drive, an optical disk, and so forth).

One or more I/O devices 416 allow a user 251 to enter commands and information to the computing device 418, and also allow information to be presented to the user 251 and/or other components or devices. Examples of input devices 416 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 418 (also sometimes called a computer system 418) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 418 includes at least the minimal processing, input, and/or output means necessary to practice one or more embodiments.

Further, those skilled in the art will appreciate that one or more elements of the aforementioned computer device 418 is located at a remote location and connected to the other elements over a network in certain example embodiments. Further, one or more embodiments is implemented on a distributed system having one or more nodes, where each portion of the implementation (e.g., the hydraulic subsea valve evaluation system 225) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

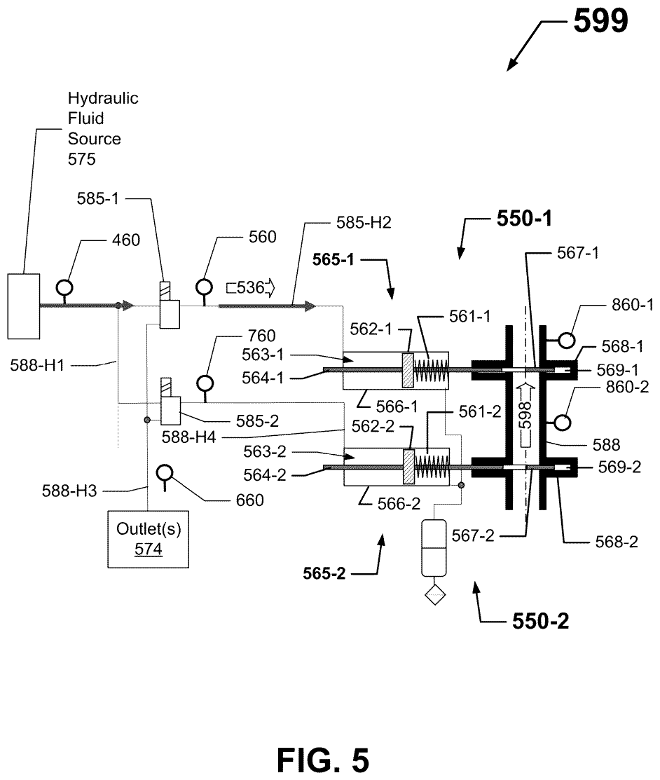

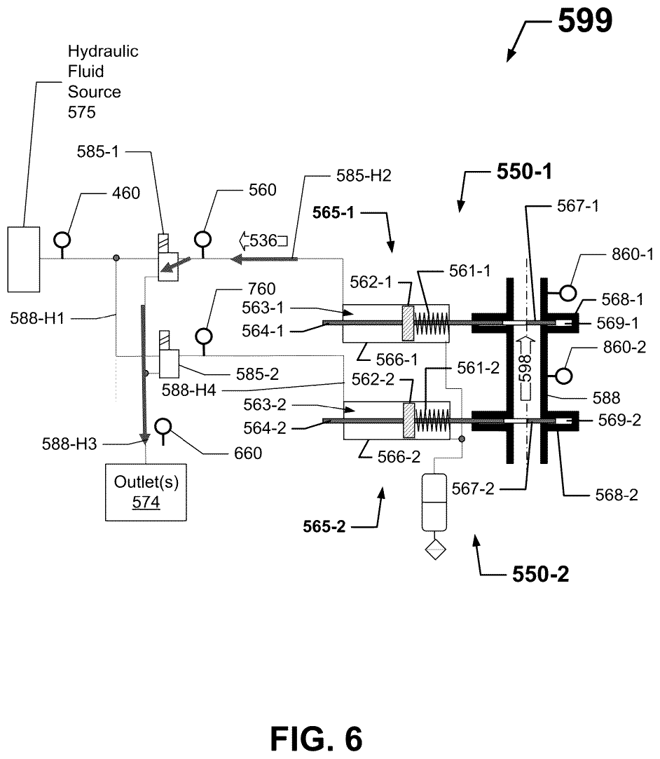

FIG. 5 shows a hydraulic valve system 599 with the hydraulic valve 550 being moved toward a fully open position according to certain example embodiments. FIG. 6 shows the hydraulic valve system 599 of FIG. 5 with the hydraulic valve 550 being moved toward a fully closed position according to certain example embodiments. Referring to FIGS. 1 through 6, the hydraulic valve system 599 of FIG. 5 is substantially the same as the hydraulic subsea valve system 299 of FIG. 2B, except as discussed below. For example, the hydraulic valve system 599 of FIG. 5 includes a hydraulic fluid source 575 that stores and pumps out hydraulic fluid 536 into a network of hydraulic lines 588-H. Specifically, the hydraulic fluid 536 flows out of the hydraulic fluid source 575 through piping 588-H1 to a control valve 585-1. In this case, the hydraulic valve system 599 is located on land (or otherwise out of water) as opposed to being subsea.

The control valve 585-1 has 3 ports in this case. One port is coupled to an end of piping 588-H1. A second port is coupled to an end of piping 588-H2. The third port is coupled to an end of piping 588-H3. When the control valve 585-1 is in a certain position, as in FIG. 5, the hydraulic fluid 536 flows from piping 588-H1 through the hydraulic fluid valve 585-1 to piping 588-H2, and no hydraulic fluid 536 flows through piping 588-H3. At the end of piping 588-H2, the hydraulic fluid 536 flows into the actuator 565-1 of the hydraulic valve 550-1.

In this example, the actuator 565-1 includes an actuator housing 566-1 that forms a cavity 563-1. Inside the cavity 563-1 are positioned a resilient device 561-1, a piston head 562-1, and a shaft 564-1 that is coupled to the piston head 562-1 and extends through a distal end of the actuator housing 566-1 to the gate housing 568-1. The resilient device 561-1 is positioned between the piston head 562-1 and the wall at the distal end of the actuator housing 566-1. The resilient device 561-1 may take on any of a number of forms, including but not limited to a spring (e.g., a compression spring (as in this case), a tension spring), a shock absorber, and a component made of an elastomeric material.

The purpose of the resilient device 561-1 is to keep the hydraulic valve 550-1 in a default position (e.g., normally closed (as in this case), normally open) until there is a sufficiently strong opposite force to overcome the force imposed by the resilient device 561-1 and move the hydraulic valve 550-1 to a different state (e.g., fully open, partially open, fully closed) relative to the default state of the hydraulic valve 550-1. The resilient device 561-1 may also be configured in such a way that the shaft 564-1 may move uninhibited as the resilient device 561-1 expands and compresses within the actuator housing 566-1.

In this case, the resilient device 561-1 has a natural tendency to push against the distal wall of the actuator housing 566-1 and the piston head 562-1 until the piston head 562-1 is pushed against the proximal wall of the actuator housing 566-1. This puts the hydraulic valve 550-1 in a fully closed position as the default position. As the hydraulic fluid 536 is pumped into the actuator housing 566-1 by the hydraulic fluid source 575 through the piping 588-H1, the control valve 585-1, and the piping 588-H2, the hydraulic fluid 536 enters through the proximal wall of the actuator housing 566-1.

When enough hydraulic fluid 536 is pumped into the cavity 563-1 of the actuator housing 566-1, under a sufficiently high pressure to overcome the force of the resilient device 561-1 applied to the piston head 562-1 toward the proximal wall of the actuator housing 566-1, the piston head 562-1 begins to move toward the distal wall of the actuator housing 566-1, and the resilient device 561-1 compresses in this example. Different forces may be applied in both directions against the piston head 562-1. Examples of forces that may push the piston head 562-1 toward the distal end of the actuator housing 566-1 may include, but are not limited to, hydraulic force applied by the hydraulic fluid 536, resistance hydrostatic force, and pressure friction (where the friction force increases with flow and/or pressure buildup within the cavity 563-1). Examples of forces that may push the piston head 562-1 toward the proximal end of the actuator housing 566-1 may include, but are not limited to, the force of the resilient device 561-1 and bore pressure. As more sufficiently pressurized hydraulic fluid 536 is pumped into the proximal end of the cavity 563-1 of the actuator housing 566-1, the piston head 562-1 continues to move toward the distal end of the actuator housing 566-1, and the resilient device 561-1 continues to compress.

Eventually, when the resilient device 561-1 may no longer compress, the pressurized hydraulic fluid 536, which fills the majority of the cavity 563-1 of the actuator housing 566-1, maintains the resilient device 561-1 in a fully compressed state, and the piston head 562-1 is pushed as far toward the distal wall of the actuator housing 566-1 as possible, for as long as the hydraulic fluid 536 maintains a minimum threshold pressure that overcomes the force applied by the fully compressed resilient device 561-1.

The distal end of the shaft 564-1 is coupled to the gate 567-1, which is movably disposed within a cavity 569-1 of the gate housing 568-1. In this way, when the piston head 562-1 moves within the actuator housing 566-1, the shaft 564-1 also moves the same distance and in the same direction. As the shaft 564-1 moves, the gate 567-1 moves the same distance and in the same direction within the gate housing 568-1. In this case, when the resilient device 561-1 is in its natural state in the cavity 563-1 of the actuator housing 566-1 (e.g., where there is no hydraulic fluid 536 in the cavity 563-1 of the actuator housing 566-1, when there is hydraulic fluid 536 flowing to the cavity 563-1 of the actuator housing 566-1 but at an insufficient pressure), the gate 567-1 blocks the interior of the piping 588, preventing flow of the fluid 598 therethrough. Under this configuration, the hydraulic valve 550-1 is fully closed in its normal (default) position.

At the point in time captured in FIG. 5, the piston head 562-1 is a bit more than half way toward the distal end of the actuator housing 566-1, and the gate 567-1 is a bit more than half way toward the distal end of the gate housing 568-1. As such, the gate 567-1 as shown in FIG. 5 blocks a bit less than half of the interior of the piping 588, and so the fluid 598 may flow through the piping 588 at a relatively reduced rate. When the hydraulic fluid 536 forces the piston head 562-1 toward the distal end of the actuator housing 566-1 until the resilient device 561-1 is fully compressed, the gate 567-1 is in a fully open position, allowing for the fluid 598 to flow at a maximum rate therethrough.

In this example, the network of hydraulic lines 588-H also facilitate the flow of the hydraulic fluid 536 from the hydraulic fluid source 575 to a second hydraulic valve 550-2. The hydraulic valve 550-2 (including components thereof) may be configured substantially the same as (such as in this case), or differently than, the configuration of the hydraulic valve 550-1 (including corresponding components thereof). For example, as the hydraulic fluid 536 flows out of the hydraulic fluid source 575 through piping 588-H1 to the control valve 585-1 associated with the hydraulic valve 550-1, the hydraulic fluid 536 also flows to the control valve 585-2 associated with the hydraulic valve 550-2. The control valve 585-2 may be configured substantially the same as (such as in this case), or differently than, the configuration of the control valve 585-1.

For example, the control valve 585-2 has 3 ports in this case. One port is coupled to an end of piping 588-H1. A second port is coupled to an end of piping 588-H4. The third port is coupled to an end of piping 588-H3, the other end of which leads to one or more outlets 574. When the control valve 585-2 is in a certain position, as in FIG. 5, the hydraulic fluid 536 flows from piping 588-H1 through the hydraulic fluid valve 585-2 to piping 588-H4, and no hydraulic fluid 536 flows through piping 588-H3 to the one or more outlets 574. At the end of piping 588-H4, the hydraulic fluid 536 flows into the actuator 565-2 of the hydraulic valve 550-2.

In this example, the actuator 565-2 includes an actuator housing 566-2 that forms a cavity 563-2. Inside the cavity 563-2 are positioned a resilient device 561-2, a piston head 562-2, and a shaft 564-2 that is coupled to the piston head 562-2 and extends through a distal end of the actuator housing 566-2 to the gate housing 568-2. The resilient device 561-2 is positioned between the piston head 562-2 and the wall at the distal end of the actuator housing 566-2.

The purpose of the resilient device 561-2 is to keep the hydraulic valve 550-2 in a default position (e.g., normally closed (as in this case), normally open) until there is a sufficiently strong opposite force to overcome the force imposed by the resilient device 561-2 and move the hydraulic valve 550-2 to a different state (e.g., fully open, partially open, fully closed) relative to the default state of the hydraulic valve 550-2. The resilient device 561-2 may also be configured in such a way that the shaft 564-2 may move uninhibited as the resilient device 561-2 expands and compresses within the actuator housing 566-2.

In this case, the resilient device 561-2 has a natural tendency to push against the distal wall of the actuator housing 566-2 and the piston head 562-2 until the piston head 562-2 is pushed against the proximal wall of the actuator housing 566-2. This puts the hydraulic valve 550-2 in a fully closed position as the default position. As the hydraulic fluid 536 is pumped into the actuator housing 566-2 by the hydraulic fluid source 575 through the piping 588-H1, the control valve 585-2, and the piping 588-H4, the hydraulic fluid 536 enters through the proximal wall of the actuator housing 566-2.

When enough hydraulic fluid 536 is pumped into the cavity 563-2 of the actuator housing 566-2, under a sufficiently high pressure to overcome the force of the resilient device 561-2 applied to the piston head 562-2 toward the proximal wall of the actuator housing 566-2, the piston head 562-2 begins to move toward the distal wall of the actuator housing 566-2, and the resilient device 561-2 compresses in this example. As more sufficiently pressurized hydraulic fluid 536 is pumped into the proximal end of the cavity 563-2 of the actuator housing 566-2, the piston head 562-2 continues to move toward the distal wall of the actuator housing 566-2, and the resilient device 561-2 continues to compress.

Eventually, when the resilient device 561-2 may no longer compress, the pressurized hydraulic fluid 536, which fills the majority of the cavity 563-2 of the actuator housing 566-2, maintains the resilient device 561-2 in a fully compressed state, and the piston head 562-2 is pushed as far toward the distal wall of the actuator housing 566-2 as possible, for as long as the hydraulic fluid 536 maintains a minimum threshold pressure that overcomes the force applied by the fully compressed resilient device 561-2.

The distal end of the shaft 564-2 is coupled to the gate 567-2, which is movably disposed within a cavity 569-2 of the gate housing 568-2. In this way, when the piston head 562-2 moves within the actuator housing 566-2, the shaft 564-2 also moves the same distance and in the same direction. As the shaft 564-2 moves, the gate 567-2 moves the same distance and in the same direction within the gate housing 568-2. In this case, when the resilient device 561-2 is in its natural state in the cavity 563-2 of the actuator housing 566-2 (e.g., where there is no hydraulic fluid 536 in the cavity 563-2 of the actuator housing 566-2, when there is hydraulic fluid 536 flowing to the cavity 563-2 of the actuator housing 566-2 but at an insufficient pressure), the gate 567-2 blocks the interior of the piping 588, preventing flow of the fluid 598 therethrough. Under this configuration, the hydraulic valve 550-2 is fully closed in its normal (default) position.

At the point in time captured in FIG. 5, the piston head 562-2 is a bit more than half way toward the distal end of the actuator housing 566-2, and the gate 567-2 is a bit more than half way toward the distal end of the gate housing 568-2. As such, the gate 567-2 as shown in FIG. 5 blocks a bit less than half of the interior of the piping 588, and so the fluid 598 may flow through the piping 588 at a relatively reduced rate. When the hydraulic fluid 536 forces the piston head 562-2 toward the distal end of the actuator housing 566-2 until the resilient device 561-2 is fully compressed, the gate 567-2 is in a fully open position, allowing for the fluid 598 to flow at a maximum rate therethrough.

In alternative embodiments, a separate hydraulic fluid source may be used to provide hydraulic fluid to the hydraulic valve 550-2. In such cases, the network of hydraulic lines 588-H for the hydraulic valve 550-1 may be partially or completely separate from the network of hydraulic lines 588-H for the hydraulic valve 550-2. Similarly, the control valve 585-1 and the control valve 585-2 may operate independently of each other or in concert with each other. Further, the hydraulic valve 550-1 and the hydraulic valve 550-2 may be part of a single unit or individual units.

Example embodiments include multiple sensor devices (e.g., sensor devices 360) in this case. For example, sensor device 460 is configured to measure one or more parameters (e.g., a flow rate, a pressure) with respect to the hydraulic fluid 536 in the piping 588-H1. As another example, sensor device 560 is configured to measure one or more parameters (e.g., a flow rate, a pressure) with respect to the hydraulic fluid 536 in the piping 588-H2. As yet another example, sensor device 660 is configured to measure one or more parameters (e.g., a flow rate, a pressure) with respect to the hydraulic fluid 536 in the piping 588-H3.

As still another example, the sensor device 760 may be configured to measure one or more parameters (e.g., a flow rate, a pressure) with respect to the hydraulic fluid 536 in the piping 588-H4. As yet another example, sensor device 860-1 and sensor device 860-2 are configured to measure one or more parameters (e.g., a flow rate, a pressure) with respect to the fluid 598 in the piping 588. The sensor device 860-2 in this case is located between the gate housing 568-1 of the hydraulic valve 550-1 and the gate housing 568-2 of the hydraulic valve 550-2. The sensor device 860-1 is positioned along the piping 588 so that the gate housing 568-1 of the hydraulic valve 550-1 is positioned between the sensor device 860-1 and the sensor device 860-2.

In certain example embodiments, sensor device 460, sensor device 560, sensor device 660, and sensor device 760 are part of the example hydraulic valve evaluation system 225. Other sensor devices (e.g., sensor device 360) not shown in FIGS. 5 and 6 may be used in one or more alternative embodiments. For example, sensor devices in the form of proximity sensors may be installed on or in the actuator housing 566-1 toward the proximal end and the distal end to detect the presence of the piston head 562-1 to indicate when the hydraulic valve 550-1 is closed or open, respectively.

Referring now to FIG. 6, the position of the control valve 585-1 in FIG. 6 has changed relative to its position in FIG. 5 so that the hydraulic fluid 536 flows out of the cavity 563-1 of the actuator housing 566-1 and through the piping 588-H2 to the control valve 585-1. From there, the hydraulic fluid 536 continues to flow through the control valve 585-1 through the piping 588-H3 to the one or more outlets 574. When the control valve 585-1 is in the position shown in FIG. 6, no hydraulic fluid flows through the piping 588-H1.

The hydraulic fluid 536 flows out of the cavity 563-1 of the actuator housing 566-1 because the pressure of the hydraulic fluid 536 is not sufficient to overcome the force imposed by the resilient device 561-1 against the piston head 562-1 toward the proximal end of the actuator housing 566-1. As a result, the resilient device 561-1 expands until the piston head 562-1 abuts against the proximal end of the actuator housing 566-1, pushing substantially all of the hydraulic fluid 536 out of the cavity 563-1 of the actuator housing 566-1. As this occurs, the shaft 564-1 moves toward the proximal end of the actuator housing 566-1, which in turn forces the gate 567-1 to move toward the proximal end of the gate housing 568-1. As this occurs, the gate 567-1 goes from blocking little or no part of the cavity within the piping 588 (e.g., fully open) to fully blocking the cavity within the piping 588 (e.g., fully closed). When the gate 567-1 fully blocks the cavity within the piping 588, the fluid 598 no longer flows within the piping 588.

Similarly, the position of the control valve 585-2 in FIG. 6 has changed relative to its position in FIG. 5 so that the hydraulic fluid 536 flows out of the cavity 563-2 of the actuator housing 566-2 and through the piping 588-H4 to the control valve 585-2. From there, the hydraulic fluid 536 continues to flow through the control valve 585-2 through the piping 588-H3 to the one or more outlets 574. When the control valve 585-2 is in the position shown in FIG. 6, no hydraulic fluid flows through the piping 588-H1.

The hydraulic fluid 536 flows out of the cavity 563-2 of the actuator housing 566-2 because the pressure of the hydraulic fluid 536 is not sufficient to overcome the force imposed by the resilient device 561-2 against the piston head 562-2 toward the proximal end of the actuator housing 566-2. As a result, the resilient device 561-2 expands until the piston head 562-2 abuts against the proximal end of the actuator housing 566-2, pushing substantially all of the hydraulic fluid 536 out of the cavity 563-2 of the actuator housing 566-2. As this occurs, the shaft 564-2 moves toward the proximal end of the actuator housing 566-2, which in turn forces the gate 567-2 to move toward the proximal end of the gate housing 568-2. As this occurs, the gate 567-2 goes from blocking little or no part of the cavity within the piping 588 (e.g., fully open) to fully blocking the cavity within the piping 588 (e.g., fully closed). When the gate 567-2 fully blocks the cavity within the piping 588, the fluid 598 no longer flows within the piping 588.

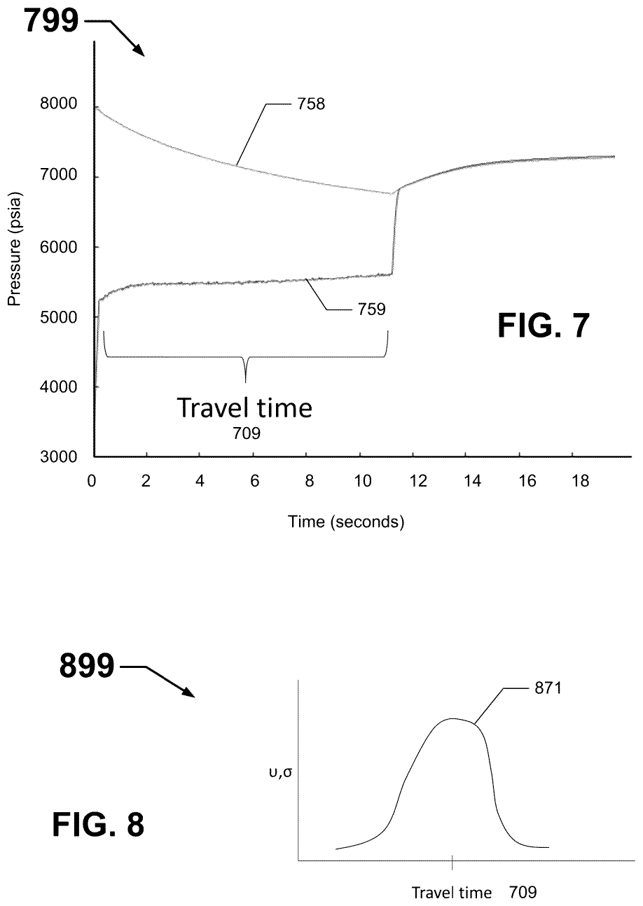

FIG. 7 shows a graph 799 illustrating evaluating the hydraulic valve 550-1 according to certain example embodiments. Referring to FIGS. 1 through 7, the graph 799 of FIG. 7 shows two plots. One plot 758 shows pressure (in psia) of the hydraulic fluid 536 (e.g., as measured by the sensor device 460, as measured by the sensor device 560) used for the hydraulic valve 550-1 along the vertical axis versus time (in seconds) along the horizontal axis. The other plot 759 shows pressure (in psia) of the actuator 565-1 of the hydraulic valve 550-1 (e.g., as measured by a sensor device (e.g., sensor device 260) measuring pressure within the cavity 563-1 of the actuator housing 566-1) along the vertical axis versus time (in seconds) along the horizontal axis.

Prior to time zero, when the hydraulic valve 550-1 is in its default (fully closed) position and the resilient device 561-1 is fully expanded, the pressure within the cavity 563-1 of the actuator housing 566-1 is less than 4000 psia, which is substantially the same as the hydrostatic head of the water (e.g., water 294). At time zero, the hydraulic fluid 536 begins to be injected into the cavity 563-1 of the actuator housing 566-1 at a pressure of approximately 8000 psia. This causes the pressure within the cavity 563-1 of the actuator housing 566-1 to spike upward within the first second to approximately 5500 psia.

As the hydraulic fluid 536 continues to be injected into the cavity 563-1 of the actuator housing 566-1 at a higher pressure (in this case, between 7000 psia and 8000 psia), the hydraulic fluid 536 forces the resilient device 561-1 to compress as the piston head 562-1 moves toward the distal end of the actuator housing 566-1. The pressure within the actuator housing 566-1 remains substantially constant at approximately 5500 psia during this travel time 709, which lasts approximately 11.5 seconds. When the resilient device 561-1 may no longer compress as the piston head 562-1 is forced toward the distal end of the actuator housing 566-1, the pressure of the hydraulic fluid 536 and the pressure within the actuator housing 566-1 equalize at approximately 7200 psia. During this time (after approximately 11.5 seconds), the hydraulic valve 550-1 is fully open.

FIG. 8 shows a graph 899 illustrating evaluating the hydraulic valve 550-1 according to certain example embodiments. Referring to FIGS. 1 through 8, the graph 899 of FIG. 8 shows a plot 871 of the standard deviation (a) and the mean (p) of the travel time 709 of the piston head 562-1 within the actuator housing 566-1 (and so also the gate 567-1) of the hydraulic valve 550-1. The plot 871 may be based on data (e.g., pressure measurement values, calculated pressure values, flow rate measurement values) associated with travel time 709 captured over time for the hydraulic valve 550-1 and/or for other hydraulic valves 550 (e.g., hydraulic valve 550-2). There may be plots 871 for travel times 709 for opening the hydraulic valve 550-1 and/or for closing the hydraulic valve 550-1.

As the plot 871 shows, there is an average travel time 709 with a distribution that is based on any of a number of factors, including but not limited to pressure within the cavity 563-1 of the actuator housing 566-1, the pressure of the hydraulic fluid 536 flowing in the piping 588-H2, and the flow rate of the hydraulic fluid 536 flowing in the piping 588-H2. Fluctuations in any of these factors result in the distribution shown in the plot 871. Greater fluctuations result in widening the plot 871, while lesser fluctuations result in narrowing the plot 871.

Data used to generate the plot 871 of the graph 899 may be used to indicate a potential problem when compared with current values associated with measurements of one or more parameters. For example, if a hydraulic valve 550-1 takes too long to open (e.g., has a travel time 709 that is longer than the average travel time 709 by a threshold amount), then there may be friction developing in the piston head 562-1 and/or the shaft 564-1 relative to the actuator housing 566-1. As another example, if a hydraulic valve 550-1 opens too quickly (e.g., has a travel time 709 that is less than 2 standard deviations of the historical or prior travel times 709), then there may be an issue with the resilient device 561-1.

FIGS. 9A through 9D show a graph 999 and related equations illustrating evaluating the hydraulic valve 550-1 according to certain example embodiments. Referring to FIGS. 1 through 9D, the graph 999 of FIG. 9A shows two plots that are substantially similar to the plots of the graph 799 of FIG. 7. One plot 958 shows pressure (in psia) of the hydraulic fluid 536 (e.g., as measured by the sensor device 460, as measured by the sensor device 560) used for the hydraulic valve 550-1 along the vertical axis versus time (in seconds) along the horizontal axis. The other plot 959 shows pressure (in psia) of the actuator 565-1 of the hydraulic valve 550-1 (e.g., as measured by a sensor device (e.g., sensor device 260) measuring pressure within the cavity 563-1 of the actuator housing 566-1) along the vertical axis versus time (in seconds) along the horizontal axis.

In this case, a series of formulas (forms of algorithms 333) that evaluate the hydraulic valve 550-1 by relating differential pressure across the actuator housing 566-1 to flow of the hydraulic fluid 536. Integration 908 across the flow of the hydraulic fluid 536 provides the volume of the cavity 563-1 of the actuator housing 566-1. The following equation (repeated as FIG. 9B) used in this example is Darcy's equation:

$$Q = {C}_{v} \sqrt{dP / sg}$$

where Q is the discharge (flow) rate of the hydraulic fluid 536 into or away from the cavity 563-1 of the actuator housing 566-1, Cᵥ is a coefficient that quantifies the flow restriction of the flow path to the hydraulic fluid 536, dP is the change in pressure before and after the direction control valve, for example, pressure differential of pressure sensor 460 and 560 or 560 and 660, sg is the specific gravity of the hydraulic fluid.

From there, an integration through time may be performed using the following equation (repeated as FIG. 9C):

$$\frac{sg}{{C}_{ν}} {V}_{act} = {\int }_{0}^{T} \sqrt{dP} dt$$

where V_{act} is volume of the actuator cavity, and dt is a change over time.

One or more integrals, as shown below and repeated as FIG. 9D, may be used as a measure of the performance of the hydraulic valve 550-1:

$$indicator = \frac{{\int }_{0}^{T} \sqrt{dP} dt}{{[ {\int }_{0}^{T} \sqrt{dP} dt ]}_{historical}}$$

Using this latter equation, if the indicator is equal to 1, the performance of the hydraulic valve 550-1 is considered normal. If the indicator is less than 1, and if it is assumed that Cᵥ does not change, then the hydraulic valve 550-1 is not opening fully. If it is assumed that the actuator 565-1 of the hydraulic valve 550-1 is not leaking, then there is less restriction (e.g., wear) in the actuator 565-1 and/or the network of hydraulic lines 588-H. If the indicator is greater than 1, and if it is assumed that C, does not change, then there is a leak in the actuator 565-1 and/or the network of hydraulic lines 588-H. If it is assumed that the hydraulic valve 550-1 is not leaking, then there is a restriction developing in the actuator 565-1 and/or the network of hydraulic lines 588-H. A distribution of the indicator may be a bell curve, similar to what is shown with the plot 871 of FIG. 8, relative to a standard deviation, a mean, or some other measure.

FIG. 10 shows a flowchart 1010 of a method for evaluating hydraulic subsea valves according to certain example embodiments. While the various steps in this flowchart 1010 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 10 may be included in performing this method. Accordingly, the specific arrangement of steps should not be construed as limiting the scope. Further, a particular computing device, such as the computing device 418 discussed above with respect to FIG. 4, may be used to perform or facilitate performance of one or more of the steps (or portions thereof) for the method shown in FIG. 10 in certain example embodiments. Any of the functions (or portions thereof) performed below by a controller 304 may involve the use of one or more protocols 332, one or more algorithms 333, and/or stored data 334 stored in a storage repository 331. In addition, or in the alternative, any of the functions (or portions thereof) in the method may be performed by a user (e.g., user 251). In some cases, one or more of the various steps in the method of FIG. 10 may be performed automatically, as by a controller 304 of the hydraulic subsea valve evaluation system 225.

The method shown in FIG. 10 is merely an example that may be performed by using an example system described herein. In other words, systems for evaluating hydraulic subsea valves may perform other functions using other methods in addition to and/or aside from those shown in FIG. 10. Referring to FIGS. 1 through 10, the method shown in the flowchart 1010 of FIG. 10 begins at the START step and proceeds to step 1081, where values associated with measurements of one or more parameters are obtained. As used herein, the term “obtaining” may include receiving, retrieving, accessing, generating, etc. or any other manner of obtaining the information.

A parameter may include, but is not limited to, a pressure, a temperature, a chemical composition, and a flow rate. In certain example embodiments, the parameters may be associated with a hydraulic fluid (e.g., hydraulic fluid 536), a network of hydraulic lines (e.g., the network of hydraulic lines 588-H), and/or a hydraulic subsea valve (e.g., the hydraulic subsea valve 550-1). Some or all of the values may be measured by one or more sensor devices (e.g., a sensor device 260, a sensor device 360). In addition, or in the alternative, some or all of the values may be calculated by a controller 304 of the hydraulic subsea valve evaluation system 225 based on measurements of one or more parameters. The values may be continuous or discrete over a period of time (e.g., a second, a minute, an hour, a day, a week, a month).

The values may be obtained by a controller (or an obtaining component thereof), which may include the controller 304 of the hydraulic subsea valve evaluation system 225 of FIG. 3 above, using one or more algorithms 333, one or more protocols 332, the communication module 307, the transceiver 324, and/or the application interface 326. The values may be obtained from a user 251, including an associated user system 255. In addition, or in the alternative, the values may be obtained from one or more sensor devices (e.g., sensor device 360) that measure one or more of the various parameters.

In step 1082, one or more algorithms 333 are executed using the values to generate a result. The one or more algorithms 333 may be executed by the controller 304 of the hydraulic subsea valve evaluation system 225 of FIG. 3 above using one or more other algorithms 333, one or more protocols 332, and/or stored data 334. The values may include current values and/or historical (prior) values retrieved from the stored data 334. In some cases, one or more of the algorithms 333 may be modified (e.g., by the controller 304, by a user 251). For example, if the result generated is found to be (e.g., through subsequent manual inspection) or believed to be (e.g., using measurements of other sensor devices (e.g., sensor device 260, sensor device 360) incorrect, one or more of the algorithms 333 may be modified in a way designed to eliminate the error.

In such cases, an algorithms 333 may be modified by the controller 304 of the hydraulic subsea valve evaluation system 225 using one or more protocols 332, one or more other algorithms 333, and/or stored data 334. In addition, or in the alternative, an algorithm 333 may be modified by a user 251, including an associated user system 255. In some cases, one or more of the algorithms 333 may be modified based on a comparison of actual values versus forecast values for some parameter associated with the hydraulic fluid 536, a hydraulic subsea valve 550, and/or the fluid 598 flowing through the piping 588 and the gate housing 568 of the hydraulic subsea valve 550.

In some cases, the one or more algorithms 333 executed to generate a result allows the evaluation module 336 (or other part) of the controller 304 of the hydraulic subsea valve evaluation system 225 to perform data analysis using one or more signatures of the hydraulic subsea valve 550. For example, one or more of the algorithms 333 may use a number (e.g., six) of performance indicators of the hydraulic subsea valve 550 that are based on the differential pressure of the signatures of the hydraulic subsea valve 550. For a signature of the hydraulic subsea valve 550 in the fully open position, the paired signatures may be, for example, the pressure (e.g., measured by the sensor device 560) of the hydraulic fluid 536 in the network of hydraulic lines 588-H (e.g., in piping 588-H2) and the pressure within the cavity 563 of the actuator housing 566. For a signature of the hydraulic subsea valve 550 in the fully closed position, the paired signatures may be, for example, the pressure (e.g., measured by the sensor device 660) of the hydraulic fluid 536 in the network of hydraulic lines 588-H (e.g., in piping 588-H3) and the pressure within the cavity 563 of the actuator housing 566.

Examples of outputs of one or more of the algorithms 333 may include, but are not limited to, the standard deviation of the differential pressure, the maximum value of the differential pressure, the minimum value of the differential pressure, the mean value of the differential pressure, an integration (e.g., the Darcy value) of the differential pressure with respect to time, and the travel time 709 of the piston head 562 of the actuator 565 of the hydraulic subsea valve 550.

In some cases, the evaluation module 336 (or other part) of the controller 304 of the hydraulic subsea valve evaluation system 225 may be configured to filter out bad signatures or outputs (results) of an algorithm 333. Such a bad signature or output may be discovered by comparing it with historical (prior) results of the algorithm 333 for that hydraulic subsea valve 550 and/or for similar hydraulic subsea valves 550. In some cases, the prior results of the algorithm 333 include prior values associated with the parameter measured by a sensor device (e.g., sensor device 260, sensor device 360) and that are associated with the actuator 565 of the hydraulic subsea valve 550. In addition, or in the alternative, the prior results of the algorithm 333 include prior values associated with the parameter from other sensor devices, where the prior values are associated with another actuator of another hydraulic subsea valve, and where the other hydraulic subsea valve is used in another subterranean field operation.

As another example, if the hydraulic subsea valve 550 is already in a fully open position, a command to put the hydraulic subsea valve 550 in the fully open position may cause the next signature of the hydraulic subsea valve 550 to be straight lines that does not include information about actual opening of the hydraulic subsea valve 550 in the pressure signals. Example embodiments may include one or more algorithms 333 that are configured to filter out those bad signatures or outputs from being studied further.

In some cases, data associated with one or more hydraulic subsea valves 550 may be used collectively to evaluate one or more other hydraulic subsea valves 550. In such cases, the hydraulic subsea valves 550 may have one or more common characteristics (e.g., be from the same manufacturer, have the same configuration, operate at the same depth in the water 294, be used in the same field operation, operate at the same pressure). In such cases, the performance data of those hydraulic subsea valves 550 may be substantially similar. In some cases, if the differences in one or more characteristics of different hydraulic subsea valves 550 were significant enough, some interpolation (e.g., scale adjustment, shifting) could be applied to allow the historical data between the hydraulic subsea valves 550 to be used in evaluating one of the hydraulic subsea valves 550. As a result, the performance indicators of the same hydraulic subsea valve 550 on different subsea Xmas trees 240 and/or subsea manifolds 270 may be clustered. Outliers (found in step 1083 below) from these clusters may indicate deviated performance from normal behavior of the hydraulic subsea valve 550 that should be studied in more depth.

In step 1083, the result of step 1082 is compared with a range of acceptable values. The range of acceptable values may be part of the stored data 334. The comparison of the result to the range of acceptable values may be performed by the evaluation module 336 or the control engine 306 of the controller 304 of the hydraulic subsea valve evaluation system 225 using one or more other algorithms 333, one or more protocols 332, and/or stored data 334. In addition to the stored data 334, the comparison of the result to the range of acceptable values may be performed using one or more protocols 332 and/or one or more algorithms 333. The result and/or the range of acceptable values may be or include numbers, words, symbols, phrases, and/or any other type of designation.

In step 1084, a determination is made as to whether there is a failure (e.g., an actual failure, a potential failure) of the hydraulic subsea valve 550. The determination as to whether there is a failure of the hydraulic subsea valve 550 may include details about the failure (e.g., a leak in the network of hydraulic lines 588-H, a failed seal around the piston head 562 making contact with the inner surface of the actuator housing 566, a bent shaft 564). In some cases, the determination as to whether there is a failure of the hydraulic subsea valve 550 may include the extent of the failure (e.g., likely functional for approximately the next month, completely inoperable).

The determination as to whether there is a failure of the hydraulic subsea valve 550 may be made by the evaluation module 336 or the control engine 306 of the controller 304 of the hydraulic subsea valve evaluation system 225 using one or more other algorithms 333, one or more protocols 332, and/or stored data 334. In addition, or in the alternative, a user 251 (including an associated user system 255) may make the determination as to whether there is a failure of the hydraulic subsea valve 550. The time history of the various indicators of the signatures of the hydraulic subsea valve 550 may be evaluated to show the development of operational issues of the hydraulic subsea valve 550. Signatures of hydraulic subsea valves 550 may be processed on a regular basis and incorporated into the historical trends, range of acceptable values, updates to algorithms 333, etc. If there is a failure of the hydraulic subsea valve 550, then the process proceeds to step 1086. If there is a failure of the hydraulic subsea valve 550, then the process proceeds to step 1087.

In step 1086, a notification about the failure is sent. The notification may be sent by the control engine 306 of the controller 304 of the hydraulic subsea valve evaluation system 225 using one or more other algorithms 333, one or more protocols 332, stored data 334, the communication module 307, the transceiver 324, and/or the application interface 326. The notification may be sent to one or more users 251 (including associated user systems 255) and/or the network manager 280. The notification may be in any format (e.g., text message, email, broadcast recording, flashing indicator light on a control panel) that is acceptable by the intended recipient.

In step 1087, a determination is made as to whether the field operations involving the hydraulic subsea valve 550 are continuing. The determination as to whether the field operations involving the hydraulic subsea valve 550 are continuing may be made by the controller 304 of the hydraulic subsea valve evaluation system 255 using one or more protocols 332, one or more other algorithms 333, stored data 334, input from a user 251 (including an associated user system 255), measurements made by one or more of the sensor devices (e.g., sensor devices 260, sensor devices 360), and/or any other information. In addition, or in the alternative, the determination as to whether the field operations involving the hydraulic subsea valve 550 are continuing may be made by a user 251 (including an associated user system 255). If the field operations involving the hydraulic subsea valve 550 are continuing, then the process reverts to step 1081. If the field operations involving the hydraulic subsea valve 550 have stopped, then the process proceeds to the END step.

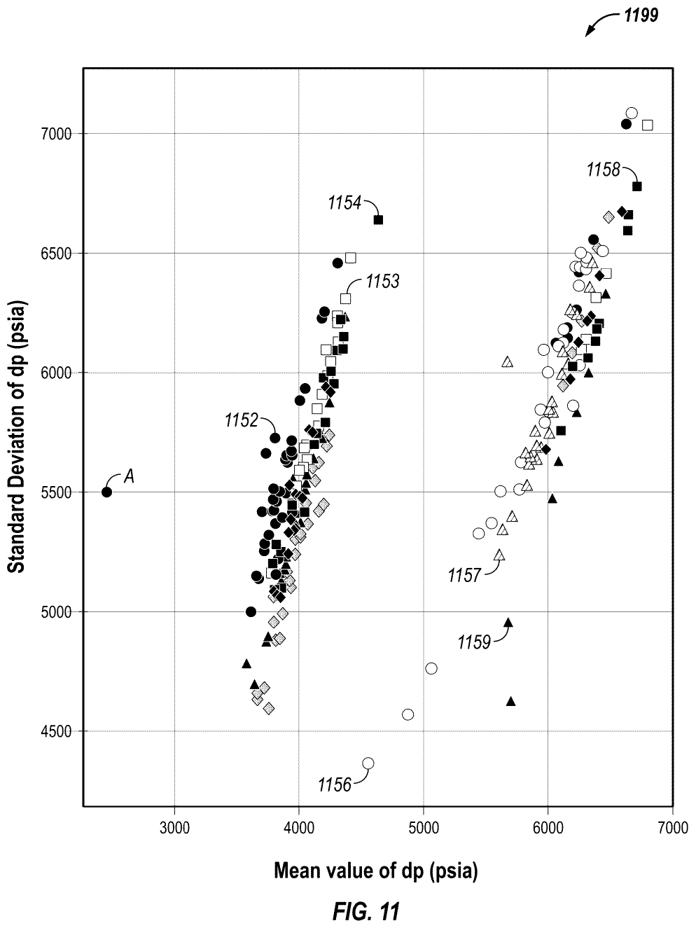

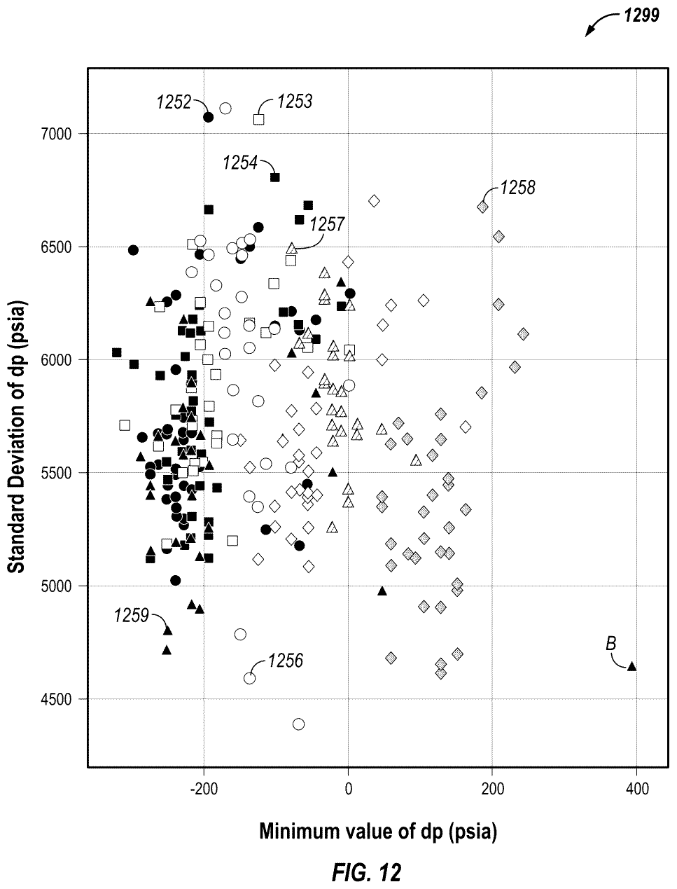

FIGS. 11 and 12 show graphs with scatter plots of various indicators for multiple hydraulic subsea valves (e.g., hydraulic subsea valves 250, hydraulic subsea valves 550) according to certain example embodiments. Specifically, FIG. 11 shows a graph 1199 with a scatter plot of data points for seven hydraulic subsea valves over time, and FIG. 12 shows a graph 1299 with a scatter plot of different data points for the seven hydraulic subsea valves over time. Referring to FIGS. 1 through 12, the graph 1199 of FIG. 11 shows scatter plots for seven hydraulic subsea valves 550 with the standard deviation of the differential pressure (in psia) along the vertical axis and the mean value of the differential pressure (in psia) along the horizontal axis.

The differential pressure may be the difference between the pressure of the hydraulic fluid (e.g., hydraulic fluid 536) at a point (e.g., piping 588-H2) in the network of hydraulic pipes (e.g., network of hydraulic pipes 588-H) and the pressure inside the cavity (e.g., cavity 563-1) of the actuator housing (e.g., actuator housing 566-1) of a hydraulic subsea valve (e.g., hydraulic subsea valve 550-1). Plot points 1152 correspond to one hydraulic subsea valve (e.g., hydraulic subsea valve 250, hydraulic subsea valve 550). Plot points 1153 correspond to a second hydraulic subsea valve. Plot points 1154 correspond to a third hydraulic subsea valve. Plot points 1156 correspond to a fourth hydraulic subsea valve. Plot points 1157 correspond to a fifth hydraulic subsea valve. Plot points 1158 correspond to a sixth hydraulic subsea valve. Plot points 1159 correspond to a seventh hydraulic subsea valve.

In most cases, each group of plot points for a hydraulic subsea valve are grouped along a line, plus or minus an error margin, with respect to each other. One notable exception is point A, belonging to plot point 1152, which is an outlier. Because point A seems to be so far outside the range of expected values relative to the rest of the plot points 1152, point A could be an erroneous value or an indication of a failure of the hydraulic subsea valve 550. Additional data and/or analysis by the controller 304 of the hydraulic subsea valve evaluation system 225 may lead to a determination as to which of these scenarios is correct.

The graph 1299 of FIG. 12 shows scatter plots for seven hydraulic subsea valves 550 with the standard deviation of the differential pressure (in psia) along the vertical axis and the minimum value of the differential pressure (in psia) along the horizontal axis. The differential pressure here may be the same as the differential pressure in the graph 1199 of FIG. 11. Plot points 1252 correspond to one hydraulic subsea valve (e.g., hydraulic subsea valve 250, hydraulic subsea valve 550). Plot points 1253 correspond to a second hydraulic subsea valve. Plot points 1254 correspond to a third hydraulic subsea valve. Plot points 1256 correspond to a fourth hydraulic subsea valve. Plot points 1257 correspond to a fifth hydraulic subsea valve. Plot points 1258 correspond to a sixth hydraulic subsea valve. Plot points 1259 correspond to a seventh hydraulic subsea valve. The seven hydraulic subsea valves in this case may be the same as the seven hydraulic subsea valves 550 in FIG. 11.

In most cases, each group of plot points for a hydraulic subsea valve 550 are grouped along a substantially vertical line, plus or minus an error margin, with respect to each other. One notable exception is point B, belonging to plot point 1259, which is an outlier. Because point B seems to be so far outside the range of expected values relative to the rest of the plot points 1259, point B could be an erroneous value or an indication of a failure of the hydraulic subsea valve (e.g., hydraulic subsea valve 250, hydraulic subsea valve 550). Additional data and/or analysis by the controller 304 of the hydraulic subsea valve evaluation system 225 may lead to a determination as to which of these scenarios is correct.

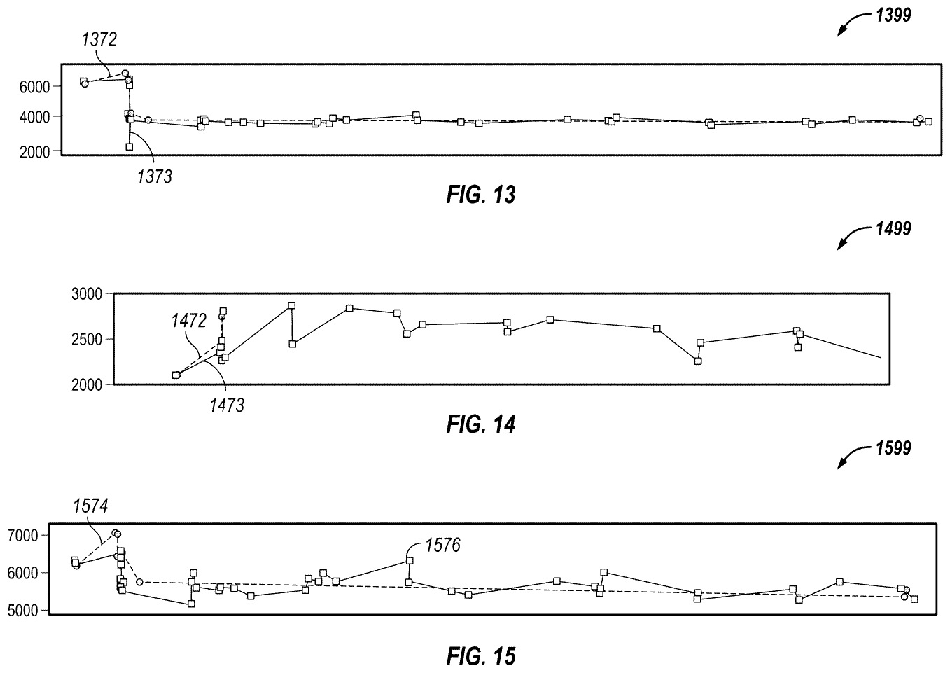

FIGS. 13 through 16 shows graphs of performance statistics over time for hydraulic subsea valves according to certain example embodiments. Referring to FIGS. 1 through 16, FIG. 13 shows a graph 1399 with two plots of the mean value of differential pressure (in psia) along the vertical axis over time (in years) along the horizontal axis when the hydraulic subsea valve (e.g., hydraulic subsea valve 250, hydraulic subsea valve 550) is in the fully open position. Plot 1372 shows values for initial performance indicator for channel A, and plot 1373 shows values for outlier of the performance indicator. The two plots of the graph 1399 show valve performance history of both A and B channels.

FIG. 14 shows a graph 1499 with two plots of the mean value of differential pressure (in psia) along the vertical axis over time (in years) along the horizontal axis when the hydraulic subsea valve (e.g., hydraulic subsea valve 250, hydraulic subsea valve 550) is in the fully closed position. Plot 1472 shows values for channel A, and plot 1473 shows values for channel B. The two plots of the graph 1499 show valve performance history of both A and B channels.

FIG. 15 shows a graph 1599 with two plots of the standard deviation of differential pressure (in psia) along the vertical axis over time (in years) along the horizontal axis when the hydraulic subsea valve (e.g., hydraulic subsea valve 250, hydraulic subsea valve 550) is in the fully open position. Plot 1574 shows values for channel A, and plot 1576 shows values for channel B. The two plots of the graph 1599 show valve performance history of both A and B channels.

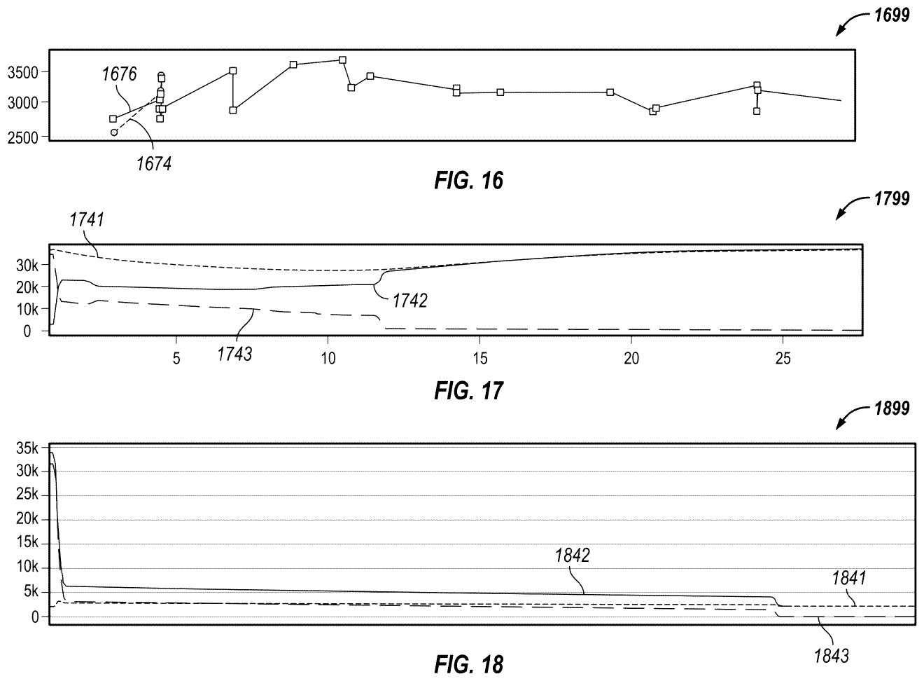

FIG. 16 shows a graph 1699 with two plots of the standard deviation of differential pressure (in psia) along the vertical axis over time (in years) along the horizontal axis when the hydraulic subsea valve (e.g., hydraulic subsea valve 250, hydraulic subsea valve 550) is in the fully closed position. Plot 1674 shows values for channel A, and plot 1676 shows values for channel B. The two plots of the graph 1699 show valve performance history of both A and B channels.

FIGS. 17 and 18 show graphs of performance signatures for a hydraulic subsea valves according to certain example embodiments. Referring to FIGS. 1 through 18, the graph 1799 of FIG. 17 shows three plots of the average signature for a group of hydraulic subsea valves (e.g., hydraulic subsea valves 250, hydraulic subsea valves 550) with pressure (in kPa) along the vertical axis and time (in seconds) along the horizontal axis. Plot 1741 represents the pressure of the hydraulic fluid (e.g., hydraulic fluid 236, hydraulic fluid 536) in the piping (e.g., piping 588-H2) of the network of hydraulic lines (e.g., the network of hydraulic lines 588-H) before entering the actuator (e.g., actuator 565) of the group of hydraulic subsea valves. Other variables that may be measured and tracked on a graph such as the graph 1799 of FIG. 17 may include, but are not limited to, the minimum differential pressure, the maximum differential pressure, the Darcy value, and the travel time for channel A and/or channel B.

Plot 1742 represents the pressure within the cavity (e.g., cavity 563) of the actuator housing (e.g., actuator housing 566) of the actuator (e.g., actuator 565) of the group of hydraulic subsea valves. Plot 1743 represents the differential pressure between plot 1741 and plot 1742. The travel time (e.g., travel time 709) of the piston head (e.g., piston head 562) within the actuator housing is approximately 11 seconds based on when the plot 1743 becomes substantially zero. In addition, the seals (e.g., around the piston head, within the disc housing (e.g., disc housing 568)) are holding because after 11 seconds, the plot 1743 remains constant at substantially zero.

The graph 1899 of FIG. 18 shows three plots of the closing signature for a single hydraulic subsea valve (e.g., hydraulic subsea valve 250, hydraulic subsea valve 550) with pressure (in kPa) along the vertical axis and time (in seconds) along the horizontal axis. Plot 1841 represents the pressure of the hydraulic fluid (e.g., hydraulic fluid 236, hydraulic fluid 536) in the piping (e.g., piping 588-H2) of the network of hydraulic lines (e.g., the network of hydraulic lines 588-H) before entering the actuator (e.g., actuator 565) of the group of hydraulic subsea valves.

Plot 1842 represents the pressure within the cavity (e.g., cavity 563) of the actuator housing (e.g., actuator housing 566) of the actuator (e.g., actuator 565) of the group of hydraulic subsea valves. Plot 1843 represents the differential pressure between plot 1841 and plot 1842. The travel time (e.g., travel time 709) of the piston head (e.g., piston head 562) within the actuator housing is approximately 11 seconds based on when the plot 1843 becomes substantially zero and when plot 1842 becomes substantially the same as plot 1841. In addition, the seals (e.g., around the piston head, within the disc housing (e.g., disc housing 568)) are holding because after 11 seconds, the plot 1843 remains constant at substantially zero and plot remains constant at approximately 2000 Pa.

Example embodiments may be used to capture, trend, and identify signatures of hydraulic subsea valves. Example embodiments may use additional sensor devices to measure parameters. The values associated with these measurements may be used when executing one or more algorithms to help capture and trend the signatures of the hydraulic subsea valves. Example embodiments may continually monitor conditions to make adjustments in real time. Example embodiments result in identifying failures and potential failures in hydraulic subsea valves. In some cases, example embodiments, may identify specific parts of a hydraulic subsea valve or associated component (e.g., part of a network of hydraulic lines that provide hydraulic fluid to and receive hydraulic fluid from the hydraulic subsea valve) that have failed or are potentially failing. Example embodiments may also be used to result in more efficient operations of the hydraulic subsea valves. Example embodiments may be used with new hydraulic subsea valves and related equipment or retrofit to work with existing hydraulic subsea valves and related equipment. Example embodiments may provide a number of benefits. Such benefits may include, but are not limited to, ease of use, short commissioning time, extending the life of a hydraulic subsea valve, flexibility, configurability, and improved compliance with applicable industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for remotely evaluating a hydraulic valve, the method comprising:
obtaining a plurality of values associated with measurements of a parameter, wherein the measurements are measured by a plurality of sensor devices, wherein the plurality of sensor devices are configured to measure the parameter at a plurality of locations along a network of hydraulic lines that circulates a hydraulic fluid with respect to an actuator of the hydraulic valve, and wherein the parameter is associated with an actuator of the hydraulic valve during a subterranean field operation;
executing an algorithm using the plurality of values to generate a result;
comparing the result of the algorithm with a range of acceptable values, wherein the range of acceptable values is established using prior results of the algorithm; and
determining that the hydraulic valve has a potential failure when the result falls outside the range of acceptable values.

2. The method of claim 1, wherein the prior results of the algorithm include a plurality of prior values associated with the parameter from the plurality of sensor devices and that are associated with the actuator of the hydraulic valve.

3. The method of claim 1, wherein the prior results of the algorithm include a plurality of prior values associated with the parameter from an alternative plurality of sensor devices, wherein the plurality of prior values are associated with an alternative actuator of an alternative hydraulic valve, and wherein the alternative hydraulic valve is used in another subterranean field operation.

4. The method of claim 1, further comprising:
sending a notification about the potential failure of the hydraulic valve.

5. The method of claim 1, wherein the network of hydraulic lines comprises a control valve, a main line, a regulator, an inlet line, and a discharge line, and wherein the algorithm comprises a differential pressure that includes part of the network of hydraulic lines.

6. The method of claim 5, wherein the differential pressure is measured during a period of time when the hydraulic fluid flows to the actuator to operate the hydraulic valve.

7. The method of claim 5, wherein the differential pressure is measured during a period of time when the hydraulic fluid flows out of the actuator to operate the hydraulic valve.

8. The method of claim 1, wherein determining that the hydraulic valve has the potential failure comprises identifying particular problem with the hydraulic valve.

9. The method of claim 1, wherein the range of acceptable values is determined using a factor comprising a group consisting of a depth of the hydraulic valve in water, a manufacturer of the hydraulic valve, a model of the hydraulic valve, and type of the hydraulic fluid, and a configuration of the actuator of the hydraulic valve.

10. The method of claim 1, wherein the range of acceptable values is adjusted based on subsequent results of the algorithm using subsequent values of measurements associated with the parameter from the plurality of sensor devices.

11. The method of claim 1, wherein the range of acceptable values is adjusted based on repairs performed on the hydraulic valve relative to the potential failure.

12. A system for remotely evaluating a hydraulic valve, the system comprising:
a plurality of sensor devices that are configured to measure a parameter at a plurality of locations along a network of hydraulic lines that circulates a hydraulic fluid with respect to an actuator of the hydraulic valve, and wherein the parameter is associated with an actuator of the hydraulic valve during a subterranean field operation;
a controller communicably coupled to the plurality of sensor devices, wherein the controller is configured to:
obtain a plurality of values associated with measurements of the parameter,
wherein the measurements are measured by the plurality of sensor devices;
execute an algorithm using the plurality of values to generate a result;
compare the result of the algorithm with a range of acceptable values, wherein the range of acceptable values is established using prior results of the algorithm; and
determine that the hydraulic valve has a potential failure when the result falls outside the range of acceptable values.

13. The system of claim 12, wherein the parameter comprises a pressure.

14. The system of claim 12, wherein the range of acceptable values are relative to an amount of the time for the hydraulic valve to transition from being fully closed to fully open.

15. The system of claim 12, wherein the parameter comprises a flow rate.

16. The system of claim 12, wherein the network of hydraulic lines comprises a control valve, a main line, a regulator, an inlet line, and a discharge line, wherein the plurality of sensor devices comprises a first sensor that monitors the parameter at the main line of the network of hydraulic lines, a second sensor device that monitors the parameter at the inlet line of the network of hydraulic lines, and a third sensor device that monitors the parameter at the discharge line of the network of hydraulic lines.

17. The system of claim 16, wherein the algorithm receives as an input a differential of values of the measurements of the parameter taken at substantially the same time.

18. The system of claim 12, wherein the hydraulic valve is a gate valve.

19. The system of claim 12, wherein the network of hydraulic lines comprises a control valve, a main line, a regulator, an inlet line, and a discharge line, and wherein the plurality of sensors, the control valve, the inlet line, and the discharge line are located under water.

20. A non-transitory computer readable medium comprising computer readable program code, which when executed by a computer processor, enables the computer processor to:
facilitate obtaining a plurality of values associated with measurements of a parameter, wherein the measurements are measured by a plurality of sensor devices, wherein the plurality of sensor devices are configured to measure the parameter at a plurality of locations along a network of hydraulic lines that circulates a hydraulic fluid with respect to an actuator of the hydraulic valve, and wherein the parameter is associated with an actuator of the hydraulic valve during a subterranean field operation;
facilitate executing an algorithm using the plurality of measurements to generate a result;
facilitate comparing the result of the algorithm with a range of acceptable values, wherein the range of acceptable values is established using prior results of the algorithm; and
facilitate determining that the hydraulic valve has a potential failure when the result falls outside the range of acceptable values.
